(19) United States
(12) Patent Application Publication
(10) Pub. No.: US 2024/0399377 A1
(43) Pub. Date: Dec. 5, 2024

(54) Large-Scale Biological Sample Storage

(71) Applicant: Azenta US, Inc., Burlington, MA (US)

(72) Inventors: Richard Clarkson, Bretherton (GB); Etienne Croquette, Altrincham (GB); Anthony Barber, York (GB); Maisara Abualqumboz, Salford (GB); Michael Burslem, Monton (GB); David Lee, Burlington, MA (US); Xiqiao Yang, Warrington (GB); Stephen White, Chester (GB); Ololade Borisade, Runcorn (GB)

(21) Appl. No.: 18/668,006

(22) Filed: May 17, 2024

Related U.S. Application Data
(60) Provisional application No. 63/467,481, filed on May 18, 2023.

(51) Int. Cl. B01L 3/00; B01L 1/00; B01L 7/00; B65G 1/04

(52) U.S. Cl. CPC B01L 3/50851; B01L 1/50; B01L 7/5255; B65G 1/0492; B01L 2300/18; B65G 2201/0258

(57) ABSTRACT

An automated, large-scale, energy-efficient biological material storage and retrieval system stores large quantities of samples in trays. The system includes a heat exchanger to capture and recycle residual energy, a movable wall, a storage compartment, a multi-tray shuttle compartment with shuttle, a plenum to maintain air temperature between compartments and along the sections within the storage compartment, a mechanism to open and close dividers between compartments, and a tray connector to release or attach one or more trays within a compartment configured to minimize energy loss during operation.

### RELATED APPLICATION

This application claims the benefit of U.S. Provisional Application No. 63/467,481, filed on May 18, 2023. The entire teachings of the above application are incorporated herein by reference.

### FIELD OF THE INVENTION

The present invention relates to an energy-efficient automated system for storing, retrieval and management of large numbers of biological or chemical samples retained in an array of storage containers.

### BACKGROUND

Cold storage is essential to maintaining the integrity of biological and chemical substances over extended periods of time. At sufficiently low temperatures, chemical processes and biological functions of such substances are effectively halted, allowing them to be stored safely over various lengths of time. Pharmaceutical, chemical, medical and other scientific organizations have a need for the storage of large numbers of samples and specimens, including organizations in the fields of research, biotechnology, diagnostic, genomics, forensic, agrichemical and specialty chemical. A storage freezer enables such storage by providing an insulated and controlled cold environment to accommodate a number of biological or other samples. In typical storage freezers, samples are loaded into racks or trays, each of which holds individual samples. The racks can hold one or more trays. The racks or trays are manually removed from the cold environment of the freezer, presenting the rack or tray to a user for removing samples from, or adding samples to, the storage freezer.

To extend the useful lifetime of samples, they are stored in a controlled environment of low temperature 40 (typically −20° to −80° C. or −120 or lower), low humidity, and inert gas (such as nitrogen, argon etc.), and are subjected to as little environmental variation as possible. In order to handle very large numbers of samples in the most efficient manner, a number of considerations must be made to enhance the system's flexibility and adaptability for different applications with the smallest possible footprint to minimize the use of valuable laboratory space. An overview of currently available compound storage systems and technologies is provided by Dr. John Comley in his article entitled “Compound Management in pursuit of sample integrity’, published in Drug Discovery World, Spring 2005, pp. 59-78, which is incorporated herein by reference.

In certain applications, the samples are preferably stored at ultra-low temperatures (such as −20 to −80° C. or −120° C. or lower), however, this cold environment can be hazardous to the electro-mechanical devices that are necessary for operation of an automated system. Lubricants are less effective at such low temperatures, making the robotics less reliable. Maintenance of robotics in the sample storage area is particularly a problem because the storage environment must be opened, subjecting the samples to condensation and possible thawing. Some commercial systems isolate the robotics in a somewhat warmer compartment (−20° C.), passing the samples between the two compartments. In such systems, an insulating wall must be created between the two compartments to maintain the temperatures in each compartment. In existing systems, the sample storage areas have removable doors that are opened to obtain access to the trays. In others, the trays (or stacks of trays), have a block of insulating material at one end so that all trays together combine to form in an insulated wall, and when removed, the insulating material associated with that tray is also removed and must be replaced with a dummy block to maintain the integrity of the insulating wall. This replacement process takes time, however, increasing the risk of temperature change in one or both compartments. In still other systems, the insulating wall or tile is lifted by a mechanical arm or other device to expose the compartment holding the racks and trays and the arm is lowered to allow the tile to return to its position under gravity to its position covering the compartment, however, the rails along which such tile slides must be sufficiently slack or generously spaced to avoid friction against the tile that may cause the tile to stick and cause the environment of one compartment to remain exposed to the other compartment.

### SUMMARY

An automated energy efficient cold storage system for storing large quantities of samples in trays includes a refrigerated storage compartment, a moveable wall of insulating tiles or other material separating the storage compartment from a tray shuttle or conveyor compartment or aisle abutting the storage compartment on one side and a plurality of independent modules on the other side. A heat exchanger is configured with a plenum or duct to direct airflow to the storage compartment to maintain a consistent temperature throughout and between the racks in the storage compartment. The wall or tile is movable along rails to expose the storage compartment while maintaining sufficient friction along the rails to reduce the exposure of environments between the storage compartment and the tray shuttle compartment and reduce the energy expended to maintain the separate environments. The tray shuttle is configured to retrieve or return multiple trays to a rack in the storage compartment or the independent modules thereby improving the energy efficiency of the system by decreasing the amount of time the storage environment is exposed to the tray shuttle environment. The tray shuttle is configured with a latch that links multiple for storage and retrieval so as to engage and disengage easily when moving from the storage compartment and the tray shuttle compartment.

The modules perform processing of samples that are retrieved from the storage compartment by a tray shuttle, including extraction of selected samples from retrieved source trays and transfer of the selected samples into a separate, destination tray that can be further processed or removed from the system for use. The independent operation of the modules permits handling and processing to be performed simultaneously by different modules while the tray shuttle accesses additional samples within the storage compartment.

Example embodiments include a large-scale energy efficient system for controlling temperature of an environment and enabling automated storage and retrieval of samples. A heat exchanger may connect with an input duct (e.g., a plenum and/or other conduit) and an output duct. The input duct may be adapted to direct air from a first environment (e.g., an aisle/automation environment) to a gas input of the heat exchanger. The output duct may be adapted to direct a gas output from the heat exchanger into the first environment to heat air from a refrigeration unit before returning to the first environment (e.g., aisle/automation environment). A refrigerator may be configured to cool a second environment (e.g., a storage area) to a temperature lower than that of the first environment, the refrigerator including a liquid reservoir to cool the condenser of the refrigerator. A conduit loop may be adapted to cycle liquid from the liquid reservoir through the heat exchanger, and the heat exchanger may be configured to transfer thermal energy from the liquid to the air from the first environment.

The sample storage facility may include any suitable number of environmental zones or areas that may be connected to one another. In some aspects, the zones may have different environments and may be isolated, otherwise the zones have a shared atmosphere. Storage facility 100 in the example shown in FIG. 1 is representative and in other aspects the storage facility may have any suitable arrangement. For example, the sample storage facility 100 may include one or more storage zones/areas. The first and second environments are adjacent to one another, and may be separated by a wall including at least one moveable panel enabling passage through the wall. The first environment may be cooled by convection via the passage. The refrigerator may be configured to cool the second environment to a cold temperature. The heat exchanger may be configured to heat the first environment to a temperature to an optimal temperature. In an example embodiment, the temperature of the first environment may be at least −25 to −30° C.

The system may further include a chiller unit connected in series with the conduit loop and configured to cool the liquid. The heat exchanger may be further configured to selectively enable operation based on a detected temperature of the air from the first environment. The second environment may be a cold storage environment including a plurality of samples, and the first environment may include at least one mechanism for accessing the plurality of samples.

Further embodiments include a system for minimizing temperature variation and establish temperature equilibrium or consistency within a chamber including by deflecting or redirecting air flowing through or between locations within an air distribution system, including a conduit (e.g., plenum and/or air duct) to circulate air and one or more chambers adjacent to the air duct or plenum. The air distribution system relies on the negative pressure created by the heat exchanger unit to circulate air through the chamber adjacent to the air duct but may also operate via a fan or other mechanism to circulate the airflow. The conduit may be adapted to carry a flow of cooled air. A wall of the air duct may define a plurality of deflectors extending from a surface of the wall into the air duct. Each of the plurality of deflectors may be located a distinct distance from an inlet of the air duct, and may be adapted to direct a respective portion of the flow of cooled air through a respective aperture in the wall and into the chamber.

Each of the plurality of air deflectors may further include a portion extending from a surface of the wall into the chamber. The plurality of deflectors may extend from a surface of the wall in a direction toward a source of the flow of cooled air. The chamber may encompass a plurality of partition walls dividing a volume of the chamber into a plurality of zones adjacent to the wall of the air duct. Each of the plurality of deflectors may be adapted to direct the respective portion of the flow of cooled air into a respective one of the plurality of zones.

The chamber may encompass a plurality of columns of trays. Each of the plurality of deflectors may be adapted to direct the respective portion of the flow of cooled air through a respective one of the plurality of columns of trays. Each of the plurality of deflectors may be adapted to direct the respective portion of the flow of cooled air through a respective volume between two of the plurality of columns of trays. Each of the plurality of columns of trays may include trays having perforations that enable the flow of cooled air to pass through the column of trays. Each of the plurality of columns of trays may include trays storing a plurality of biological samples. The cooled air is at or within a temperature range appropriate for storage of samples, which may include cold temperatures.

Further embodiments include a storage system. A storage chamber may be configured to store samples, and a column of tiles may be integral to a wall (e.g., making up the wall) of the storage chamber. The storage compartment is separated from the tray shuttle compartment by stacks of foam bricks or other insulating material that are arranged to create a robotically friendly insulating wall of tiles in front of the storage trays. The tiles are arranged in stacks and held in place by gravity. Guide rails on either side of the stacks constrain the tiles against lateral movement while allowing them to slide along the rails freely. To access a particular tray, a first robotic arm moves to a tile in front of the desired tray, extends a pin or other projection into a corresponding recess in the tile, then slides all of the tiles extending along the direction of the movement of the first robotic arm to create an opening aperture in front of the desired tray or trays. The tray of interest is retrieved. A second robotic arm positioned along the same axis as the first robotic arm during a closing operation, may be configured to engage with distinct tiles of the subset and moved to push the subset of tiles in the opposite direction as the first robotic arm to return the tiles to the starting position to cover the aperture. The tiles can be of any size but smaller tiles can help to minimize any temperature change that might occur when the tiles are moved to create an aperture to remove trays. The inventive approach allows the tiles to open to a full stroke or a partial stroke of the robotic arm to expose only the trays that align with the tray conveyor units. A track may be adapted to enable the column of tiles to slide vertically or horizontally along the wall of the storage chamber. A first robotic arm, may be configured to move a subset of the column of tiles along the track to create an aperture in the wall in place of a selected tile, the subset including the selected tile and tiles located adjacent to the selected tile. Tracks and movement may be vertical or horizontal. A second robotic arm positioned along the same axis as the first robotic arm, during a closing operation, may be configured to engage with distinct tiles of the subset and move to push the subset to its original position to cover the aperture.

During the closing operation, the first and second robotic arms coordinate to position the tiles over the aperture. A further inventive aspect of this dual robotic arm operation reduces or prevents openings between the tiles by which air may escape from one environment into the other. This dual arm operation allows the tiles to fit more closely with the tile tracks enabling a tighter fit or seal between each of the subset of tiles and the tracks.

In one embodiment, during the closing operation, the first robotic arm may engage with the selected tile. During the closing operation, the second robotic arm may engage with a topmost tile of the subset of tiles. A plurality of columns of tiles may be integral to the wall of the storage chamber, the plurality of columns of tiles including the column of tiles. The first and second robotic arms may be configured to move horizontally to a selected one of the plurality of columns of tiles prior to an opening operation. A tray conveyor robot, following the opening operation, may be configured to remove an item from the storage chamber via the aperture. The item may be a tray supporting a plurality of biological samples. This operation may be used to open and close the tiles when retrieving trays but also when returning trays to the storage compartment.

Still further embodiments may include a method of moving one or more trays within the system. The tray conveyor shuttle may be a gantry type conveyor that moves on the horizontal or vertical axis and is able to retrieve any tray along the width or height of the storage compartment. This is particularly useful in the case of an ultra-cold storage compartment below 30 degrees limiting the robotic movements that can occur within the storage compartment. The system can have 1 or more tray shuttle conveyors operating in tandem along either side of the length of the aisle compartment. Still a further embodiment may include tray shuttle conveyors configured to access storage compartments on both sides of the aisle compartment. A tray latch or hook of the tray shuttle extends into the storage compartment to connect with the tray. This device is able to pull or push a tray to insert it into or remove it from a slot to store a tray, to position the tray on the conveyor and to move it to any location where an operation is to be performed. In one embodiment, a track may be moved such that first and second conveyor robots are vertically aligned with one or more selected ports of a storage compartment, the track supporting the first and second conveyor robots. The first conveyor robot may be moved such that it is horizontally aligned with the selected port. Via the first conveyor robot, a first tray may be extracted through the selected port and the first tray may be moved horizontally along the track. The second conveyor robot may then be positioned such that it is horizontally aligned with the selected port. Via the second conveyor robot, a second tray may be extracted through the selected port and moving the first tray horizontally along the track. Via the first conveyor robot, the first tray may be returned to the storage unit through the selected port.

A tile covering the selected port may be opened prior to extracting the first tray. A tile covering the selected port may be closed after returning the first tray to the storage compartment. Via the second conveyor robot, the second tray may be moved to an independent module or other access port.

The selected port may be a first port of a plurality of ports at the storage unit, and the track may be moved directionally such that first or second conveyor robots are aligned with a second port of the storage unit. In one example, the first conveyor robot may be moved such that it is horizontally aligned with the second port. Via the first conveyor robot, a third tray may be extracted through the second port and the second tray may be moved horizontally along the track. The second conveyor robot may be positioned such that it is horizontally aligned with the second port, and, via the second conveyor robot, a fourth tray may be extracted through the second port and moving the third tray horizontally along the track. Via the first conveyor robot, the third tray to the storage unit through the second port.

Yet still further embodiments include a method of connecting trays. A first tray may be positioned such that a bottom surface of the first tray is lower than a bottom surface of a second tray. At least one of the first and second trays may be moved toward one another until a bolt (or, alternatively, a lug, peg, pin, lip, protrusion, projection, or other connecting device) of the first tray contacts a surface of the second tray below a slot of the second tray, the slot being longer than a width of the bolt. The first tray may be elevated relative to the second tray until the bolt enters the slot of the second tray. At least one of the first and second trays may then be moved away from one another such that the bolt moves within the slot until the bolt contacts an end of the slot. Prior to elevating the first tray relative to the second tray, one of the first and second trays may be pushed via the other of the first and second trays.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is an isometric view of a storage system in one embodiment.

FIG. 1B is an isometric section view of the storage system.

FIG. 1C is a front section view of the storage system.

FIGS. 2A-B are lateral section views of the storage system in one embodiment.

FIGS. 3A-B are diagrams of a shuttle assembly in one embodiment.

FIG. 4 is a diagram of a conveyor assembly in one embodiment.

FIG. 5 is a diagram of a tile lifter assembly in one embodiment.

FIG. 6 is a diagram of a tile closer assembly in one embodiment.

FIG. 7 is a diagram of a tray conveyor in one embodiment.

FIG. 8 is a diagram of a tray latch assembly in one embodiment.

FIG. 9 is a diagram of a pair of tray conveyor assemblies in combination with a lateral conveyor in one embodiment.

FIG. 10 is a top-down view of a storage system in one embodiment.

FIG. 11 is a diagram of a temperature control system in one embodiment.

FIG. 12 is a diagram of a temperature control system in a further embodiment.

FIG. 13 is a diagram of an air duct defining a plurality of air deflectors in one embodiment.

FIG. 14 is a diagram of an air deflector in one embodiment.

FIG. 15 is a cross section view of an air deflector in one embodiment.

FIGS. 16A-E are diagrams illustrating a tile opening operation in one embodiment.

FIGS. 17A-D are diagrams illustrating a tray extraction operation in one embodiment.

FIGS. 18A-D are diagrams illustrating a tile closing operation in one embodiment.

FIGS. 19A-E are diagrams illustrating an operation to remove a rear tray in one embodiment.

FIGS. 20A-C are diagrams illustrating alternative embodiments implementing a single tray conveyor.

FIGS. 21A-D are diagrams illustrating a tray latching operation in one embodiment.

FIGS. 22A-B are diagrams illustrating connection features of a tray in one embodiment.

FIG. 23 is a diagram illustrating a storage tray in one embodiment.

FIGS. 24A-B are diagrams illustrating a storage shelf assembly in one embodiment.

### DETAILED DESCRIPTION

A description of example embodiments follows.

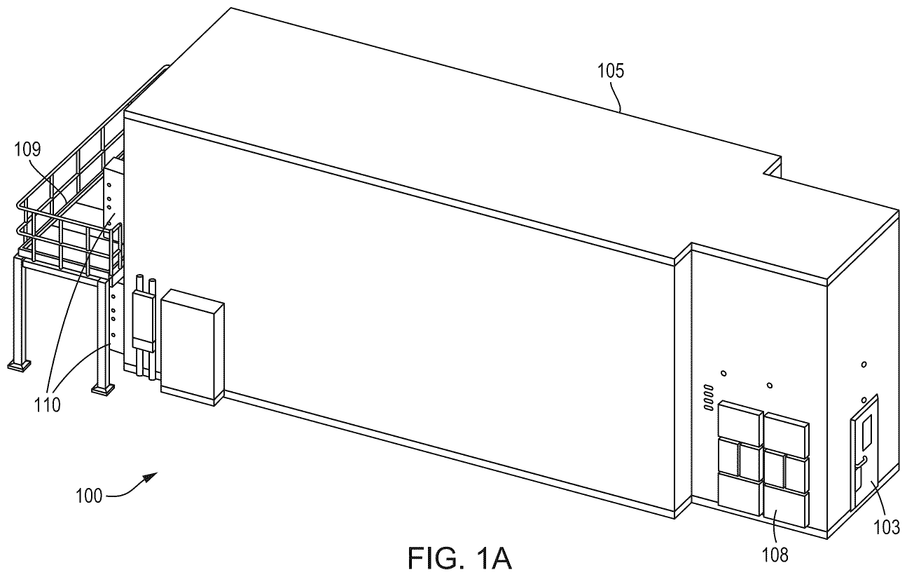

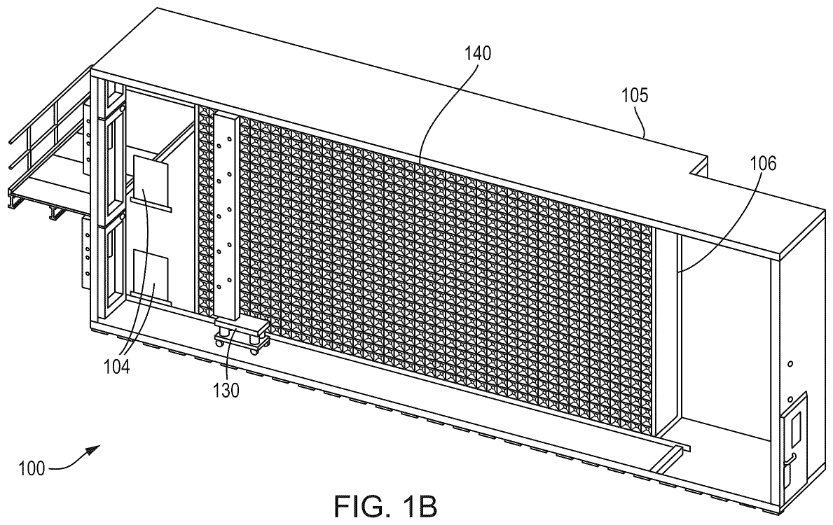

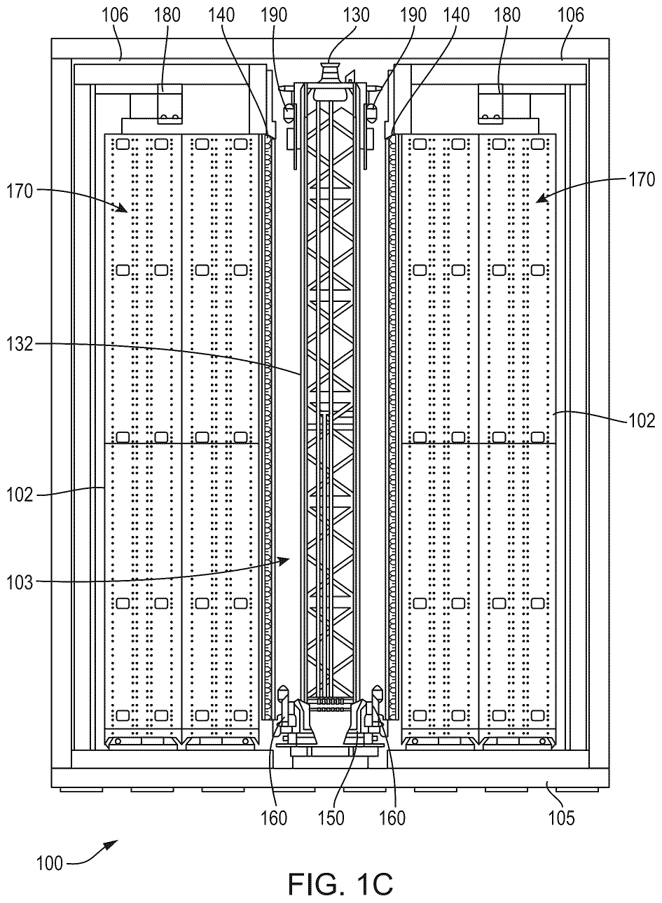

FIGS. 1A-C illustrate an automated storage system 100 in one embodiment. The storage system 100 provides for storing a substantial number (e.g., 15 million) of samples (e.g., a biological or chemical sample contained in a sealed vial) in a cold (e.g. −80° C.) environment, thereby preserving the samples for long-term storage. Optionally, the system 100 may maintain the samples below a respective glass transition temperature. In example shown, the system 100 may have overall dimensions of approximately 14 m long, 4.5 m wide, and 6 m high. An automated retrieval system housed within the system 100, described below, provides for automatically accessing, retrieving, extracting, and storing target samples to and from the system 100. The storage compartment may be configured to accept trays of varying sizes, capacities and materials, including cardboard boxes. In contrast to comparable high-volume cold storage systems, the system 100 may exhibit reduced floor space, reduced energy consumption, greater energy efficiency, and greater consolidation of inventory management.

FIG. 1A shows an isometric view of the storage system 100. An external enclosure 105 houses the internal enclosures and retrieval system described below, and a door 103 at a wall of the enclosure 105 enables an operator to enter the system 100 for maintenance or emergency operations. At another wall of the enclosure 105, access and independent input/output modules such as selector or transfer modules 108 may include multiple input/output ports at which a user may access a requested sample placed at a port by the retrieval system, and may place one or more samples for storage by the retrieval system or selectors used to transfer samples from one tray 159 to another tray 159 or an scanning device (not shown), which may be used to read bar codes, measure volume, or identify the sample on the tray 159. Each of the modules 108 may house one or more receptacles (not shown), such as test tube trays, for either holding, transferring, and/or imaging individual samples or sample trays, and may also be cooled to a temperature appropriate for short-term storage. Further, a user interface (e.g., touch-screen, workstation, etc., not shown) may be integral to the access pods 108 or the wall of the enclosure, and may display information identifying the samples located at each of the transfer modules 108. Optionally, the user interface may accept a selection, by a user, of a target sample for retrieval. A pair of refrigeration units 110 provides cooling to the system 100, and an external access platform 109 enables an operator to access the upper refrigeration unit 110 for maintenance, and may access an internal volume of the system 100 through an access door (not shown).

FIG. 1B is an isometric section view of the storage system 100, showing some of the components housed within the external enclosure 105. In particular, an internal enclosure 106 houses a storage volume for storing the aforementioned samples, which may be organized in a support structure described below. An additional internal enclosure (not shown) may be located opposite of the internal enclosure 106 as shown in FIG. 1C, described below. A tile wall 140 occupies a wall of the internal enclosure 106, and may comprise a grid of moveable tiles that together may form a seal between the storage volume and an access volume adjacent to the tile wall 140. The tiles of the tile wall 140, described in further detail below, may provide a vapor barrier and an insulating, tight seal that minimizes air leaks and heat exchange from the internal enclosure 106. A tray shuttle assembly 130 may move within the access volume along the length of the tile wall 140, and may include machinery to move one or more tiles of the tile wall to access a target address of the storage volume and remove and/or replace sample trays at the target address. Antechamber access doors 104 may enable an operator to access an antechamber to perform maintenance operations on components such as the refrigeration units 110 or plenum (described below), or to access the storage volume for emergency recovery of samples.

FIG. 1C is a front section view of the storage system 100. As shown, the two internal enclosures (cold storage compartments) 106 occupy opposite sides of the external enclosure 105, and are separated by the access volume (tray shuttle compartment) 103 in which the shuttle assembly 130 is located. Each internal enclosure 106 may house within the storage volume 102 a respective storage partition assembly 170, which may include a rack or a plurality of shelves and/or columns adapted to support the storage trays holding the stored samples. An air conduit 180 (e.g., plenum and/or air duct(s)) may be located within the antechamber of each internal enclosure 106, and may be adapted to channel air between the storage volume 102 and the refrigeration units 110.

The shuttle assembly 130 may include a shuttle mast 132 that extends vertically from the base of the shuttle assembly 130 up to approximately the height of the inner enclosure 105. The shuttle mast 132 may provide structural support to various robots and other components of the shuttle assembly 130, and may also include one or more vertical tracks along which the other components may move. In particular, a pair of tile lifter assemblies 160 may each be positioned near a respective tile wall 140, and may operate to move along the shuttle mast 132 to locate, engage with, and move a selected tile of the tile wall 140 to access a selected sample tray behind the tile wall 140. Likewise, a tray conveyor assembly 150 may move along the shuttle mast 132 to a position near an opening in the tile wall 140 created by the tile lifter assembly 140 to extract a selected tray through the opening. The tray conveyor assembly 150 may be configured to reposition itself to extract trays through either tile wall 140 at opposite sides to the shuttle assembly 140. Alternatively, the shuttle assembly 130 may include a pair of tray conveyor assemblies 150, each of which is configured to extract trays through a respective tile wall 140.

To return the tiles of the wall 140 in their original position after accessing the storage volume 102, a pair of tile closer assemblies 190 may each be positioned near a respective tile wall 140, and may operate to engage with and move a selected tile of the tile wall 140. For example, a tile closer assembly 190 may select a topmost tile of a column of tiles shifted upwards by a tile lifter assembly 160, and may move the topmost tile downward, concurrently as the tile lifter assembly 160 moves its selected tile downward, thereby closing the opening in the tile wall 140. Because the tile closer assembly 190 pushes downward on the topmost tile and, by extension, the tiles below the topmost tile, the column of tiles may return to their original positions in the tile wall 140 while minimizing air leakage through the tile wall 140. Due to the downward force provided by the tile closer assembly 190, the tiles may be fitted relatively tightly to their respective tile tracks to maintain an optimal seal at the wall 140, for example by positioning a perimeter seal of the tile such that it maintains close contact with the tracks and/or neighboring tiles. Although such a configuration may introduce additional friction against tile movement, the force provided by the tile closer assembly 190 may overcome this friction to effectively move the tiles.

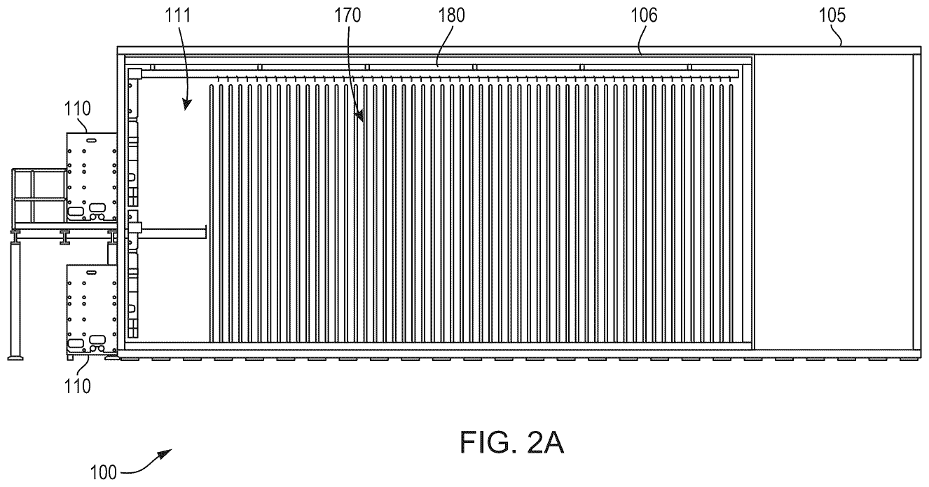

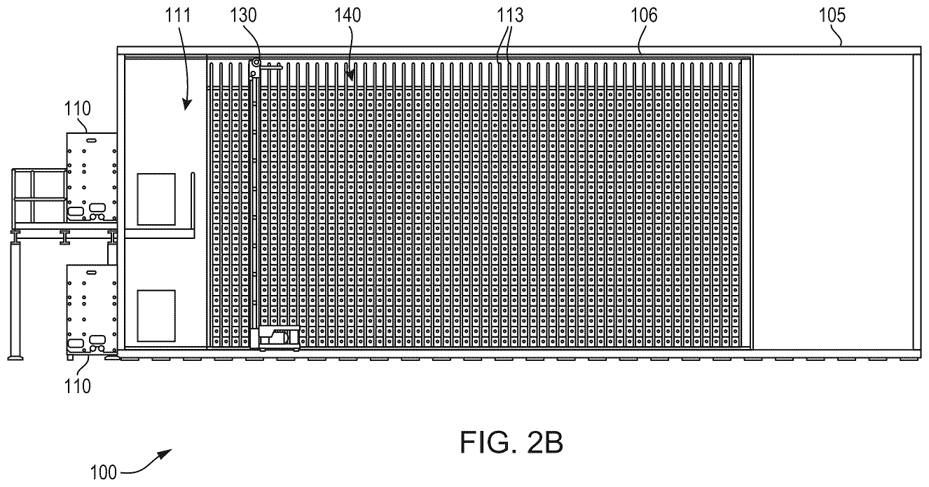

FIGS. 2A-B are lateral section views of the storage system 100. FIG. 2A is a cross section through the internal enclosure 106, showing the antechamber area 111 of the volume inside the internal enclosure 106 as well as the partition assembly 170 within the storage volume 102 of the internal enclosure 106. Further, the air conduit 180 may extend along the volume above the partition assembly 170, channeling cooled air from the refrigerator units 110 down through a plurality of partition assemblies 170 to cool the samples stored therein.

FIG. 2B is a cross section through the access volume 103 between the internal enclosures 106, showing the shuttle assembly 130 positioned in front of the tile wall 140. In the embodiment shown, the tile wall 140 is an array of tiles 50 tiles wide and 25 tiles high. Behind each tile, the storage compartment may be configured to accept one or more trays of varying sizes, capacities and materials, including cardboard boxes, for storage. Each tray may carry a number of sample tubes, vials or other container such as insulated container, and such trays may carry a large number of samples (e.g., 1,044 sample tubes). Individual trays may be pulled through an opening in the tile wall 140 and moved to one of the input/output modules 108 (see FIG. 1A) for accessing a selected sample from the tray. The shuttle assembly 130 may facilitate this transportation of trays. To do so, the shuttle assembly 130 may move left and right along the length of the tile wall 140 to position itself adjacent to a column of tiles containing a target tile, and then move the tile lifter assembly 160 and tray conveyor assembly 150 vertically along the shuttle mast 132 to engage with the target tile. The tile wall 140 may include vertical tile tracks 113 at the edges of each column of tiles. Each column of tiles may slide along a respective pair of the tile tracks 113, thereby enabling an opening in the tile wall 140 to be created by the shuttle assembly 130 at the location of any tile of the tile wall 140. Further, the tile tracks 130 may extend by the length of at least one tile above the tile wall 140 to accommodate the movement of the topmost tile of each column. By employing tiles that slide along tile tracks 113 rather than hinged doors or other access means, the system 100 reduces the space needed for retrieval and provides a reliable seal between the storage volume and access volume, which is resistant to failure under cold conditions and can be manipulated consistently by the shuttle assembly 130.

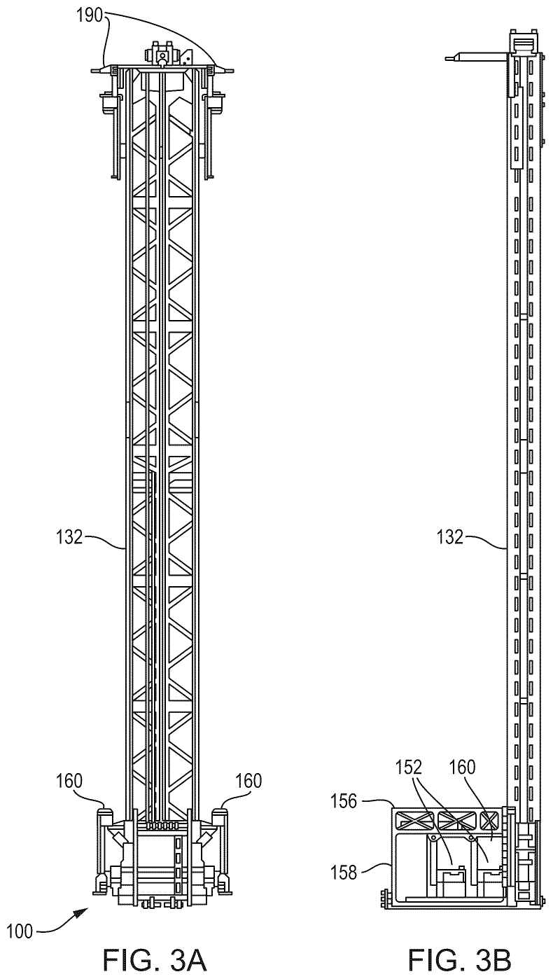

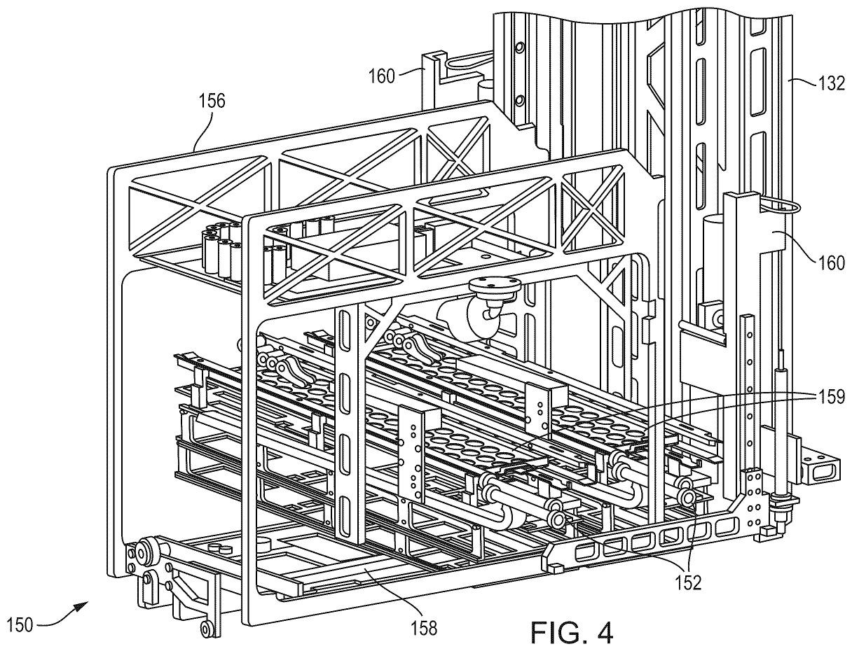

FIGS. 3A-B illustrate the shuttle assembly 130 in further detail. FIG. 3A shows a front view of the shuttle assembly 130 from along the access aisle in which it travels, while FIG. 3B shows a side view as visible from the tile walls 140. In addition to the tile opener assemblies 160, tile closer assemblies 190, tray conveyor assembly 150, and shuttle mast 132 described above, FIG. 3B also shows components of the tray conveyor assembly 150. In particular, a pair of tray conveyors 152 may operate to securely support and transport sample trays in the process of extracting or adding the trays to the storage volume 102. A tray conveyor cradle 156 and a lateral axis conveyor 158 are described in further detail below with reference to FIG. 4.

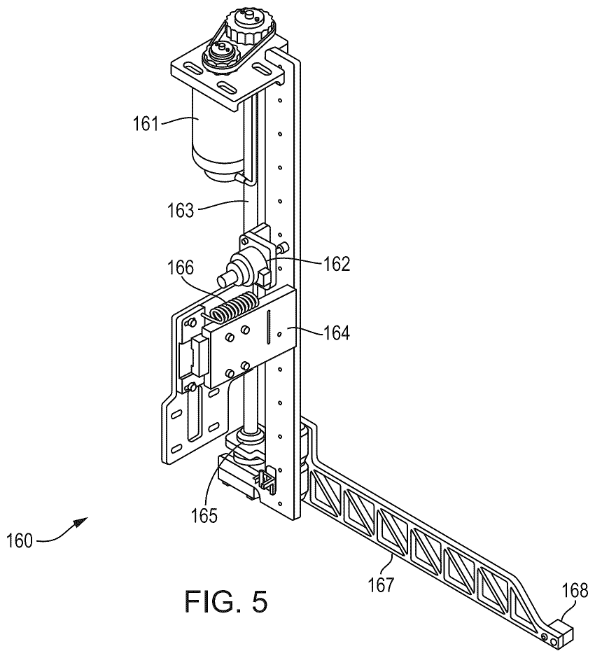

FIG. 4 illustrates the tray conveyor assembly 150, at the base of the shuttle assembly 130, in further detail. The tray conveyor cradle 156 is a support structure holding the tray conveyors 152, lateral axis conveyor 158, and associated machinery, and may be coupled to the shuttle mast 132 in a manner enabling the cradle 156 to move up and down the shuttle mast 132 in response to a command. The pair of tray conveyors 152 may securely support respective sample trays 159. During an operation of extracting a tray 159 from the storage volume 102, one or both of the tray conveyors 152 may extend out from the cradle 156 and towards the tile wall 140, and may partially enter an opening in the tile wall 140 created by the tile lifter assembly 160 to engage with and remove the target tray 159. The tray conveyors 152 may undergo this process in reverse to return or add a tray to the storage volume 102 behind the tile wall 140. To facilitate such extraction and addition, the lateral axis conveyor 158 may move the pair of tray conveyors 152 laterally, thereby allowing both of the tray conveyors 152 to access a common opening in the tile wall 140 quickly and without moving the entire shuttle assembly 130. The pair of tile lifter assemblies 160 are shown in relation to the tray conveyor assembly, and are described further below with reference to FIG. 5.

FIG. 5 shows the tile lifter assembly 160 in further detail. The tile lifter assembly 160 employs a lifter arm 167 to lift a target tile of the tile wall 140. The lifter arm 167 may terminate with a lifter lug 168, which engages with a notch, ridge, or other suitable feature of the target tile to control the motion of the tile. A lifter vertical drive assembly 161 may include a motor and drive system (including, for example, and lead screw driven by the motor) for moving the lifter arm 167 up and down during a tile lifting or tile closing operation. Alternative drive systems may include a solenoid, pneumatic cylinder, and/or a rotating count. Likewise, a lifter horizontal drive 162 may include a motor and drive system (including, for example, a linear actuator having a lead screw rotated by a stepper motor) for moving the lifter arm 167 toward and away from the tile wall 140, enabling the lifter arm 167 to selectively engage with a target tile. A guide rail assembly 163 may include a vertical guide rail on which the lifter arm 167 may move via a linear slide assembly 165. A lifter lead screw nut assembly 164 and A horizontal drive 164 of the robotic arm, including a lifter lead screw nut assembly, pushes the tile opener arm 167 forward so that projection 168 engages with the recess in the target tile. A lifter return spring 166 may retract the arm projection 167 to disengage the projection 168 from the target tile. The spring 166 may also enable service personnel to easily check alignment during commissioning that the projection 168 is aligned with the target recess.

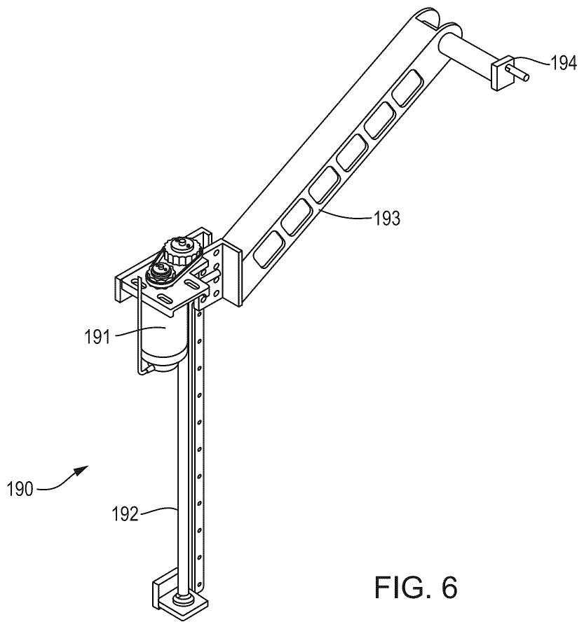

FIG. 6 shows the tile closer assembly 190 in further detail. The tile closer assembly 190 employs a closer arm 193 to lower a tile of the tile wall 140. The closer arm 193 may terminate with a closer finger or other projection 194, which engages with a recess of the top surface of a topmost tile, or a notch, ridge, or other suitable feature of the tile to control the motion of the tile. A closer drive assembly 191 may include a motor and drive system for moving the closer arm 193 up and down along a guide rail assembly 192 during a tile closing operation (e.g., via a screw drive). In an example embodiment, the tile closer assembly 190 may operate to engage with and lower the topmost tile above a target tile that was raised by the tile lifter assembly 160. In doing so, the tile closer assembly 190 may assist in lowering all of the tiles of the column above the target tile, thereby keeping the column together and preventing gaps from forming between the tiles of the column. In between tile closing operations, the closer arm 193 may be maintained such that the closer finger 194 remains above the top row of tiles of the tile wall. As a result, when the entire shuttle assembly 130 moves laterally along the tile wall 140, the closer arm 193 can move through the space above the tile wall 140 without colliding with any tiles.

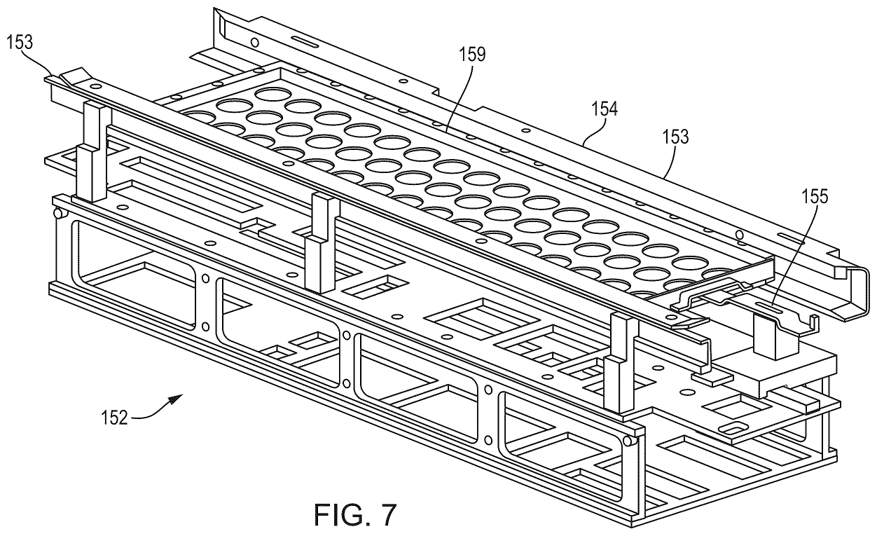

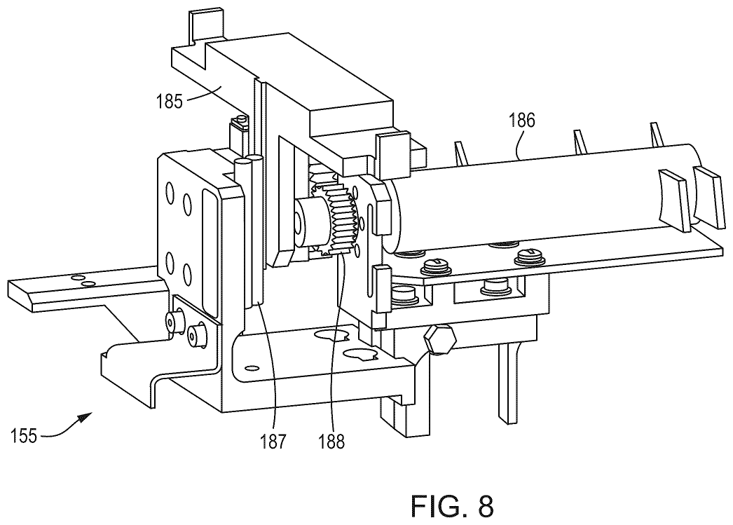

FIG. 7 shows a tray conveyor 152 in further detail. A pair of tray guide rails 153 may be spaced apart to accommodate a sample tray 159 therebetween, enabling the sample tray 159 to slide forward and backwards along the guide rails 153. A tray latch assembly 155, described in further detail below with reference to FIG. 8, may operate to extend out from the tray conveyor 152, engage with a sample tray 159 in the storage volume 102, and pull the tray 159 into the guide rails 153 of the tray conveyor 152. A quick release tray guide 154 holds the sample tray 159 securely in place and thereby maintaining engagement with the latch 155 as the shuttle travels within the aisle compartment. The quick release tray guide 154 also helps align the tray 159 with the rack ensuring it is placed into the right position. The tray guide 154 may have a number of slots, which may be wider at one side to give sufficient clearance for a screw head to pass through. The tray guide 154 can be removed by loosening the screws and then sliding the guide so the screwheads are at the widest part of the slot. This action then allows the screwheads to pass through the slot allowing the guide to be removed without fully removing the screws.

FIG. 8 shows a tray latch assembly 155 in further detail. A tray latch 185 may include a mating feature at an end of the tray latch 185, as shown, to engage with a corresponding mating feature of a sample tray 159. To facilitate this engagement, the tray conveyor 152 may move the latch assembly forward until the tray latch 185 is partially underneath the sample tray 159 and the corresponding mating features are approximately aligned. Then, a latch vertical drive motor 186 may actuate a rack and pinion 188 coupled to the tray latch 185, driving the tray latch 185 upward along a linear bearing 187 until it is coupled with the sample tray 159.

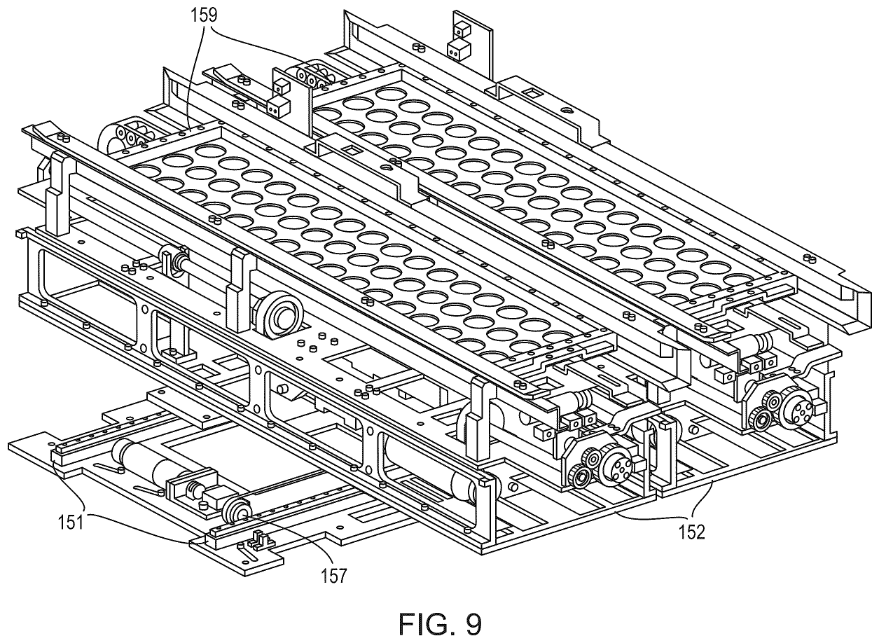

FIG. 9 shows of a pair of tray conveyor assemblies 152 in combination with a lateral axis conveyor 158. As shown, each of the tray conveyor assemblies 152 is in possession of a respective sample tray 159, and is mounted to the lateral axis conveyor 158 via a pair of lateral rails 151. The lateral axis conveyor 158 may include a lateral drive assembly 157 that operates to move one or both of the tray conveyor assemblies 152 along the pair of rails 151. Such movement may facilitate the operation of the tray conveyors 152 by repositioning them relative to an opening in the tile wall 140, thereby allowing both of the tray conveyors 152 to access a common opening in the tile wall 140 quickly and without moving the entire shuttle assembly 130.

### Temperature Control System

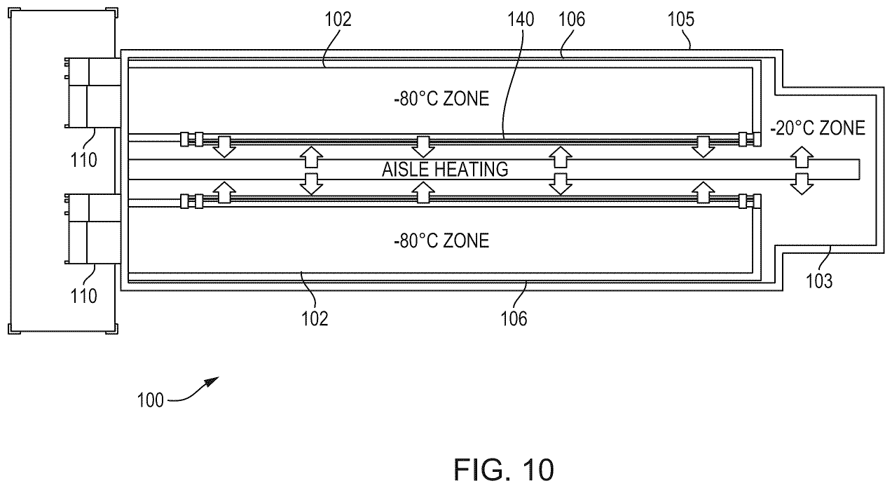

FIG. 10 is a top-down view of the storage system 100 in one embodiment. As described above, each of the internal enclosures 106 encompasses a respective storage volume 102, and the remaining volume encompassed by the external enclosure 105 is the access volume 103. The shuttle assembly 130, described above, operates within the access volume 103, and therefore may require the access volume 103 to have a minimum temperature to ensure that the shuttle assembly 130 can operate without mechanical failure. In the example shown, the access volume 103 is maintained at −20° C., while the storage volumes 102 are maintained at −80° C. However, heat conduction through the tile wall 140, as well as air transfer through openings in the tile wall 140 during access operations, may cool the access volume 103 below an acceptable temperature and heat the storage volume above an acceptable temperature.

Each refrigeration unit 110 may cool a respective storage volume to a common temperature, or the storage volumes may be cooled to different temperatures. Further, each storage compartment may itself be configured into plural volumes cooled to different temperatures.

To maintain the access volume 103 at an acceptable temperature, the system 100 may employ an electric heater (not shown) within the access volume 103. The electric heater may operate in a controlled manner, based on a measured temperature, to balance the cooling exerted by the storage volumes 102 surrounding much of the access volume 103 to create a stable environment at a target temperature. The heat load on the heater would vary depending to how many times the tile wall opens and closes, to either store or retrieve samples from the storage enclosure. When the automation opens the tile wall, the opening allows the −80° C. air from the storage enclosure to be transferred to the −20° C. automation aisle. Thus, the heat load on the aisle heating increases as the frequency of the tile wall opening increases. However, such an approach may suffer from high energy consumption. For example, an electric heater may require 12-18 kW to maintain the access volume at −20° C.

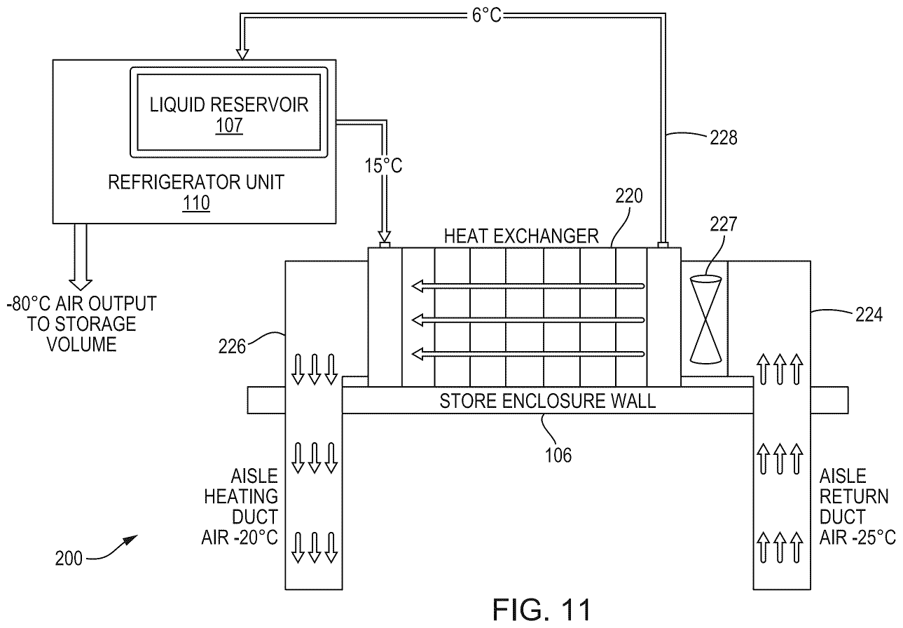

FIG. 11 illustrates a temperature control system 200 in one embodiment, which may be implemented as a supplement or alternative to the electric heater described above. During the system operation, the lower temperature air will escape/outflow into the higher temperature transport (shuttle) compartment, thereby decreasing the air temperature of the transport compartment. A condenser of the refrigeration unit 110 may be cooled by a flow of water (or air or other fluid) through a liquid reservoir 107 while the unit 110 generates cooled air (e.g., −80° C.) that is output to the storage volume 102. The system 200 may operate to use the decreased air temperature from the access/transport/shuttle compartment to use/transfer the excess cooling in the access volume 103 to the refrigeration unit 110 to pre-chill the water before it enters the refrigeration unit 110 and remove the excess heat from the air before recirculating it into the transport compartment. In doing so, the system can maintain the relative temperatures between the compartments and improve the efficiency of the refrigeration unit 110, reduce the power requirement of the refrigeration unit's water chiller, and reduce the frequency that an electrical heater in the access volume 103 needs to be activated. Thus, the system 200 may improve the heating and cooling efficiency of the storage system 100, reducing its energy consumption. Moreover, the refrigeration unit 110 may require the use of a chiller unit (not shown) to cool the water before it enters the refrigeration unit, increasing the cooling capacity of the unit 110 but requiring additional energy to cool the water. However, the system 200 may obviate the need for such a chiller unit by repurposing the excess cooling in the access volume 103 to cool the water.

The temperature control system 200 may include a heat exchanger 220, an input duct 224, an output duct 226, and a water circuit (conduit loop) 228 feeding water through the refrigeration unit 110. The input duct 224 may draw air in from the access volume 103 (e.g., from the floor or another low point in the volume) into an inlet of the heat exchanger 220. A fan 227 may blow the air through the heat exchanger 220, where it is warmed as the heat exchanger 220 transfers heat from the water circuit 228 to the air. The heat exchanger 220 blows the warmed air out through the output duct 226 and into the access volume 103 (e.g., through a ceiling or other high point in the volume). In the example shown, the system 200 warms the air from −25° C. to −20° C., while simultaneously cooling the water in the water circuit 228 from 15° C. to 6° C. Thus, the system 200 can heat the access volume 103 to a target temperature (e.g., −20° C.) while simultaneously cooling the water used to cool the refrigeration unit 110. As a result, the storage system 100 can repurpose heat within the system 100 to benefit from a greater efficiency in heating the access volume 103 and cooling the refrigeration unit 110, reducing reliance on electric heating in the access volume 103 and powered water cooling systems.

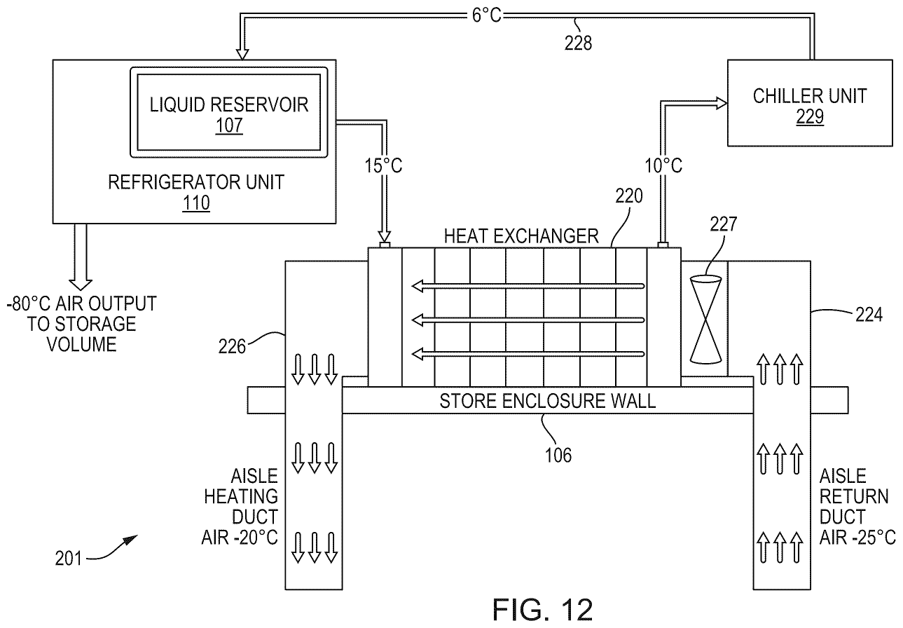

FIG. 12 illustrates a temperature control system 201 in a further embodiment. The system 201 may be configured as the system 200 described above, with the addition of a water chiller unit 229 within the water circuit 228. The water chiller unit 229 may be connected between the water outlet of the heat exchanger 220 and the water inlet of the refrigeration unit 110, and may operate to further cool the water in the circuit 228. In doing so, the heat exchanger unit 220 may reduce the heat load of the water chiller 229. For example, as shown, the heat exchanger 220 may operate to cool the water from 15° C. to 10° C. (rather than 6° C. as shown in FIG. 11), and the chiller unit 229 may further cool the water to the target temperature of 6° C. Alternatively, the water chiller unit 229 may be employed to enhance the cooling efficiency of the refrigeration unit 110 by working in tandem with the heat exchanger 220 to cool the water further than what is obtainable by the heat exchanger 220 alone.

### Air Direction System

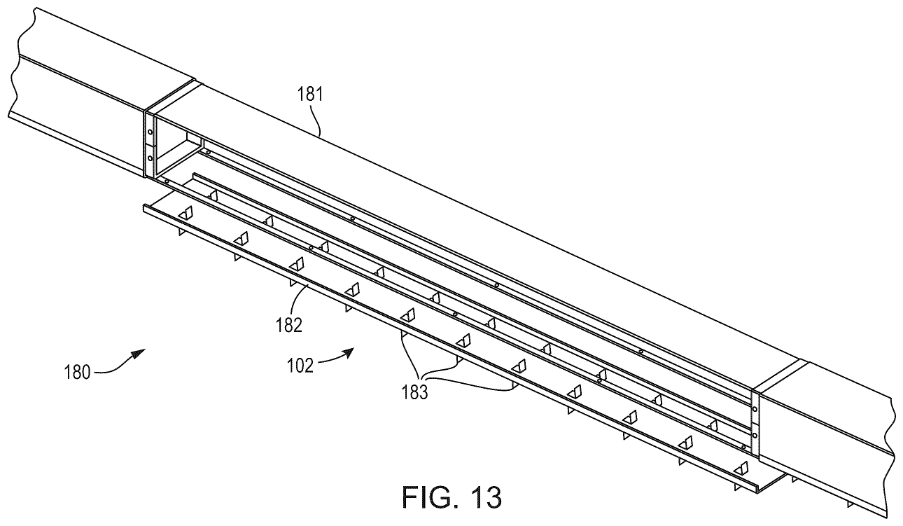

FIG. 13 illustrates a portion of the air conduit 180, including an air duct 181 defining a plurality of air deflectors 183 at a bottom wall 182 of the duct 181. As shown in FIGS. 1C and 2A, the conduit 180 carries chilled air from the refrigeration unit 110 to an upper portion of the storage volume 102 and distributes the air along the length of the storage volume 102 to cool the samples stored therein. To ensure the integrity of samples in prolonged storage within the storage volume 102, the system 100 may ensure that all portions of the storage volume 102 remain at or below a target temperature (e.g. −70° C.). To help ensure a more even distribution of heat, cold air may be circulated around the internal enclosure 106 and fed into the top of the enclosure 106 via the conduit 180.

The conduit 180 includes the air duct 181, as shown in FIG. 13, which has plurality of air deflectors 183 at a bottom wall 182 of the duct 181 to allow the air to pass through into the storage volume 102. Alternatively, the air deflectors 183 can be located at the side walls, top wall and/or end of the air duct 181. Under previous embodiments that employ simple holes along a wall of an air duct, relatively little air escapes through each of the holes, instead traversing along the top of the partition assembly 170 and then down the inner surfaces of the inner enclosure 106. As a result, excessive heat can be lost through the tile wall 140 and the walls of the inner enclosure 106.

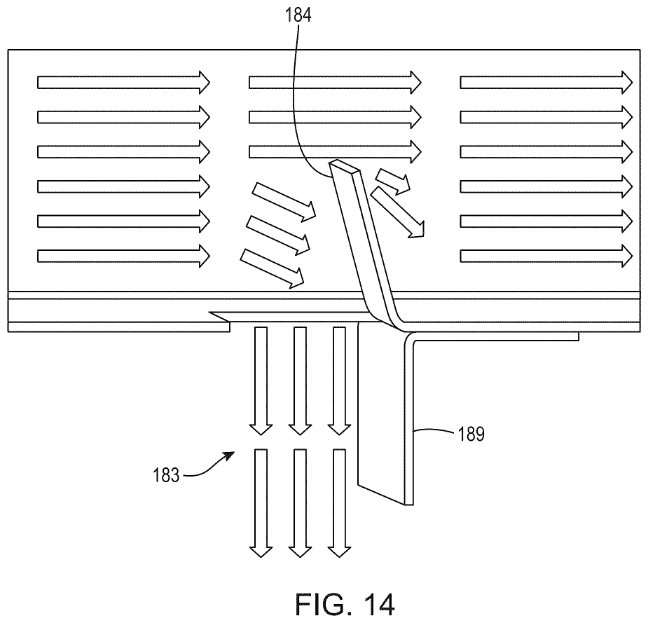

FIG. 14 shows an air deflector 183 in further detail. In contrast to previous embodiments described above, the air deflectors 183 in this example may cut a series of profiles so that an upper section 184 of the profile can be folded upwards so that it disrupts the airflow in the conduit 180 and directs the airflow downwards. A lower section 189 below the opening also directs the air downward. The sections 184, 189 encourage the air to flow down into a partition of the storage partition assembly 170 rather than across the partition. As a result, the air deflectors 183 provides a more even heat distribution in the inner enclosure 106 and prevents excessive airflow over the tile wall 140, which reduces heat leakage through the tile wall 140.

The number of air deflectors 183 cut into each bottom wall 182 of the duct 181, and the angle and length of the sections 184, 189 can be configured individually and separately and changed to compensate for any air pressure drops or changes in airflow rate or volume along the conduit (which may be measure by temperature sensors) and balance the air flow. In the example shown, the sections 184, 189 may change the direction of the airflow by 90°. Air deflectors have been used in previous air duct design to deflect air in specific areas. Such deflectors are typically positioned at the end of the duct, and direct all of the air flowing down the duct to exit through a single deflector. In contrast, each of the air deflectors 183 may be adapted to deflect only a portion of the airflow from the duct, and direct the air flow downwards, wherein the plurality of air deflectors 183 are effective to evenly distribute air downwards across a large area. Further, the profile of the air deflectors 183 allows for optimizing the number of deflectors 183 in the conduit 180 to balance the amount of air passing through the plenum to create an even airflow through the enclosure 106.

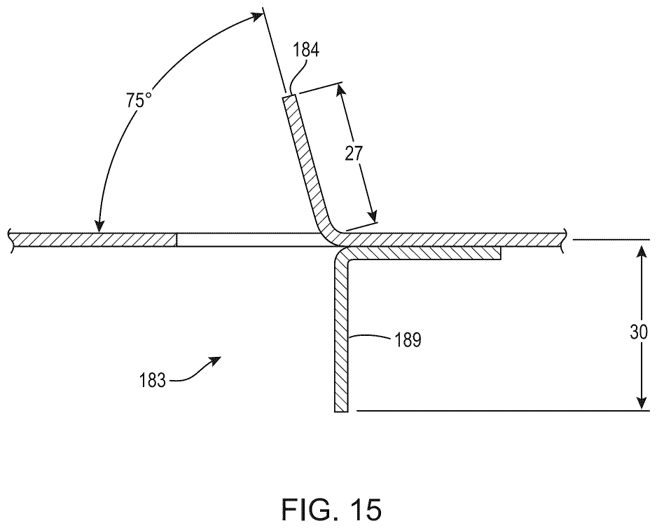

FIG. 15 is a cross section view of an air deflector 183 in one example. Here, the upper section 184 is shown to extend into the volume of the air duct 181 at an angle of 75° and length of 27 mm, and the lower section 189 extends into the storage volume 102 at an angle of 90° and length of 30 mm. The length and angle of the sections 184, 189 can be configured based on the dimensions of the air duct 181, as well as the gas composition and velocity of the air, to optimize the distribution of air within the storage volume 103. Air may be moved through the deflector 183 via the positive pressure applied to the air duct 181 as described above, as well as through negative pressure exhibited by the storage volume as a result of air intake into the refrigeration unit.

### Access Operations

Referring again to FIG. 10, the tiles of the tile wall 140 create a physical barrier between the −20° C. access volume 103 and the −80° C. storage volume 103, while still providing easy access to the samples by the shuttle assembly 130. Access to the samples can be achieved by lifting up a target tile in front of the location of the target sample tray 159. When the samples have been placed onto, or removed from, the target sample tray 159, the tiles are lowered to close the opening in the tile wall 140. Such an operation may involve all the tiles in the column above the opening to drop under gravity.

To ensure the tiles are free to fall under gravity, the tiles may be adapted to have a generous running clearance within their tile tracks 113. However, this generous clearance may also allow cold air to leak from the storage volume 102 are into the access volume 103. This causes the automation area to become colder than required. To ensure the access volume 103 does not drop lower than a threshold temperature (e.g., −30° C.) and the shuttle assembly 130 and other automation equipment can continue to operate, electric heaters may be installed in the access volume 103, as described above, to regulate the aisle temperature.

In contrast, the running clearance between the tiles and the tile tracks 113 can reduce the amount of air leaking from the storage volume 102. However, such a configuration can also increase the possibility of tiles not falling under their own weight and remaining in the “open” position. Example embodiments, described below, ensure that the tile wall 140 closes fully and quickly after a tray placement or extraction operation, thereby enabling the tile tracks 113 to be configured to minimize air leaks from the storage volume 102.

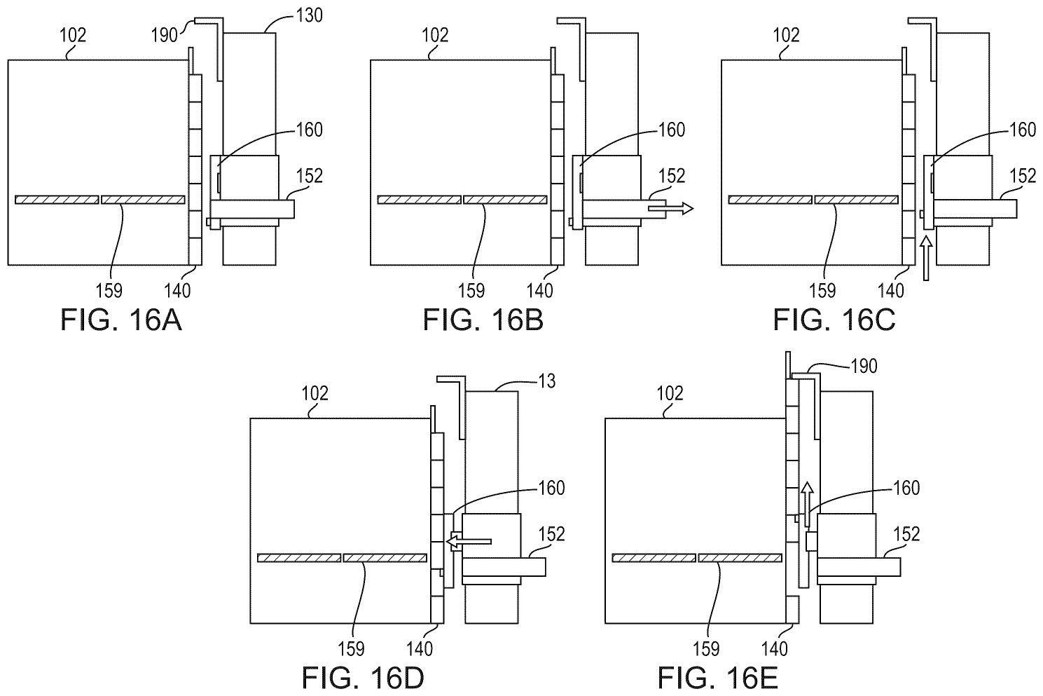

FIGS. 16A-E illustrating a portion of the system 100 during an example tile opening operation:
a) FIG. 16A: The shuttle assembly 130 aligns the tray conveyor 152 with the target tile of the tile wall 140.
b) FIG. 16B: The tray conveyor 152 moves towards the opposite tile wall to accommodate the operation of the tile lifter assembly 160.
c) FIG. 16C: The tile lifter assembly 160 moves its lifter arm 167 up or down to align the tile lifter lug 168 (see FIG. 5) with a corresponding notch or pocket of the target tile (FIG. 16C).
d) FIG. 16D: The tile lifter assembly 160 moves its lifter arm 167 towards the tile wall 140 to engage the tile lifter lug 168 with the notch of the target tile.
e) FIG. 16E: The tile lifter assembly 160 moves its lifter arm 167 upwards to raise the target tile, along with the column of tiles above the target tile, creating an opening in the tile wall 140 to access the target sample tray 159 in the storage volume 102. The top of the raised tile column may make contact or be in close proximity to the tile closer arm 193 of the tile closer assembly 190.

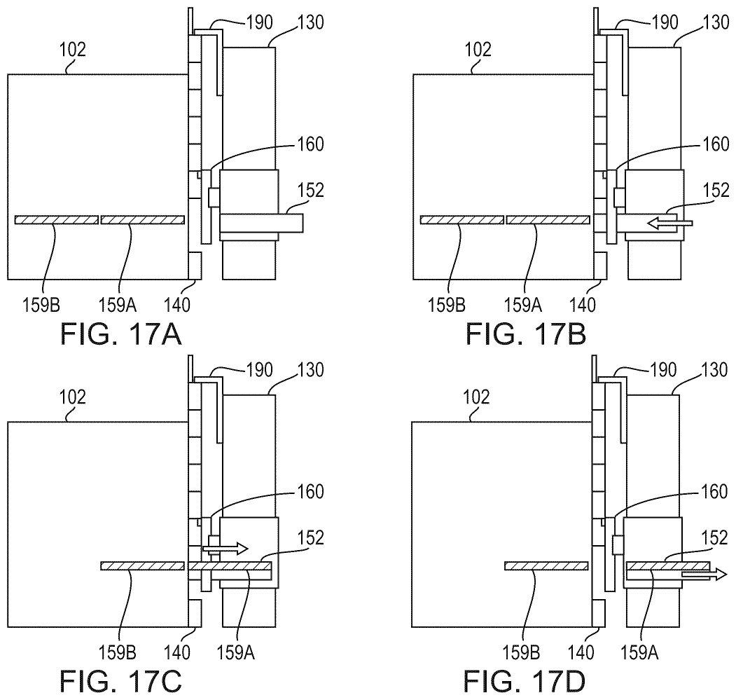

FIGS. 17A-D are diagrams illustrating an example tray extraction operation:
a) FIG. 17A: The start position for the tray extraction operation may match the final position of the tile opening operation shown in FIG. 16E, wherein the tile lifter assembly 160 has lifted a target tile to create an opening in the tile wall 140, and the tray conveyor 152 is aligned to engage with a target tray 159A.
b) FIG. 17B: The tray conveyor 152 may move toward the target tray 159A and into the opening in the tile wall 140.
c) FIG. 17C: Via the tray latch 185 (see FIG. 8), the tray conveyor 152 may engage with the target tray 159A and pull the target tray through the opening and into the tray guide rails (see FIG. 7). If the target tray 159A is coupled to another tray 159B, it may pull the other tray 159B into a front position of the storage volume 102, and the tray conveyor 152 may decouple the target tray 159A from any linked trays, for example by lowering or elevating the target tray 159A.
d) FIG. 17D: The tray conveyor 152 may then move back from the opening in the tile wall 140 such that the target tray 159A clears the opening in the tile wall 140.

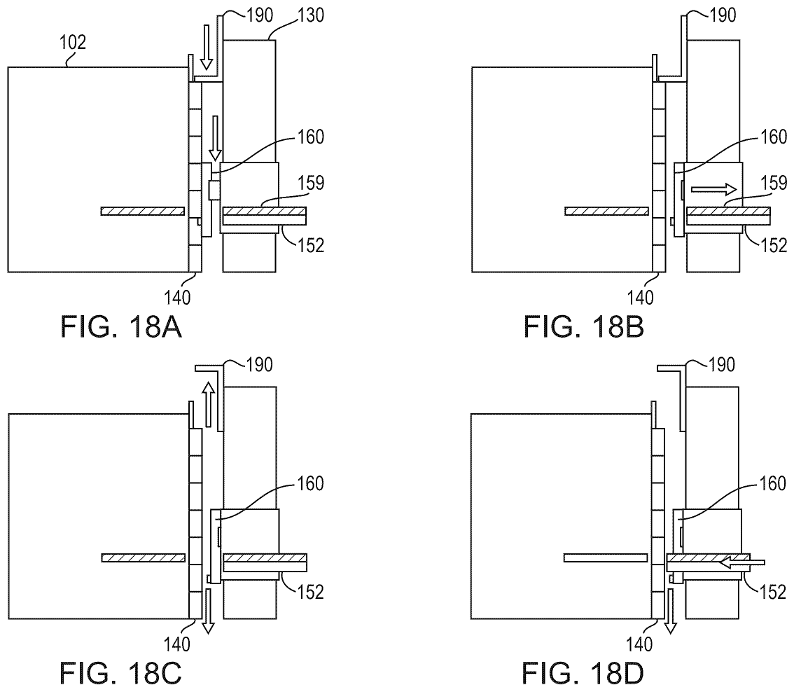

FIGS. 18A-D are diagrams illustrating an example tile closing operation:
a) FIG. 18A: From the final position of the tray extraction operation shown in FIG. 17D, the tile lifter assembly 160 and tile closer assembly 190 may operate in unison to push the column of tiles downward until the opening disappears and the tiles of the tile wall return to their original closed position. In particular, the tile lifter assembly 160 may move its lifter arm 167 downward while engaged with a notch of the target tile (see FIG. 5), and the tile closer assembly 190 may move its closer arm 193 downward while engaged with a notch or top surface of a topmost tile of the tile column (see FIG. 6).
b) FIG. 18B: The tile lifter assembly 160 may disengage from the target tile, moving away from the tile wall 140 to ensure acceptable clearance between the tile lifter assembly 160 and the tile wall 140 during movement of the shuttle assembly 130.
c) FIG. 18C: The tile lifter assembly 160 may revert to an initial configuration by lowering its lifter arm 167 to a starting position. Likewise, the tile closer assembly 190 may return to an initial configuration by moving its closer arm 193 upwards to a top position. In this top position, the closer finger 194 of the closer arm 193 may remain above the topmost tiles of the tile wall 140, enabling the shuttle assembly 130 to move within the access volume 130 without colliding with the tile wall 140. The closer finger 194 may also remain above any topmost tile when raised by the column below it, thereby preventing the closer arm 193 from interfering with a subsequent tile opening operation.
d) FIG. 18D: Lastly, the tray conveyor 152 may move to a central position relative to the shuttle assembly 130, thereby providing the shuttle assembly 130 with a greater clearance from both of the tile walls 140 when moving within the access volume 103 to position itself at a new target tile in a subsequent access operation.

When the lifter assembly lowers to return the tile walls to their closed position, it is possible one or more tiles are not fully lowered or an obstruction or other resistance prevents one or more tiles from returning to the closed position under gravity. In one embodiment, a light beam that passes above the tiles in the closed position can sense whether the top tile has fallen or remains up as the lifter assembly 160 moved down to the tile close position. If it is detected that the top tile remains up, then the tile closer assembly 190 will be engaged to press the tile wall down back into its closed position. As another embodiment, the motor to the tile closer assembly is monitored to detect an increase in electrical current or increase in time to reach the tile closed position or an increase in the following error in the motor indicating an obstruction or resistance when the tiles are lowered. To avoid potentially damaging the tiles or obstructions, a limit may be set on the time to reach the tile close position or the maximum allowable current or the permissible amount of following error to limit the downward force applied to the tile. If the time to reach the tile closed position is too long or the limit on the maximum motor current threshold is reached or the permissible amount of the following error threshold is reached then the tile lifter assembly is stopped and the tile closer assembly will not be activated or will be deactivated.

### Dual Tray Conveyor

In order to access a rear sample tray (i.e., a tray stored behind another tray relative to the tile wall 140), both the front and rear trays may need to be removed from the storage compartment 102. The front and rear trays may be joined via integral latching features as described below. To allow for two joined sample trays to be removed from the storage volume 102, a tray conveyor 152 may be modified from the configuration described above to be a “double-length” tray conveyor that can accommodate two trays within its tray guide rails 153. However, such a modification would require a wider access volume 103.

Alternatively, the shuttle assembly 130 may include robotics for separating and removing the two joined trays in succession. First, the front tray may be move away from the opening so that the rear tray can be retrieved. Then, if only the rear tray is needed, then the trays may need to be shuffled so that rear tray is removed and front tray is placed back onto the shelf within the storage volume 102. Further, when removing two joined sample trays, it may be ideal to prevent the need to close and then reopen the tile wall during the extraction process, as doing so may take an excessive amount of time, risk closing tiles on misaligned tray, cause excess wear and tear, and result in excess cold air escaping from the storage volume 102.

Referring again to FIG. 9, example embodiments may implement a pair (or one or three or more) tray conveyors 152 mounted to the lateral axis conveyor 158 via a pair of lateral rails 151. The lateral drive assembly 157 may operate to move one or both of the tray conveyors 152 along the pair of rails 151. Such movement may facilitate the operation of the tray conveyors 152 by repositioning them relative to an opening in the tile wall 140, thereby allowing both of the tray conveyors 152 to access a common opening in the tile wall 140 quickly and without moving the entire shuttle assembly 130. Thus, extraction of two trays, shuffling of the trays, and return of an unselected tray to the storage volume 102 can be completed quickly while the tile wall 140 remains open, increasing throughput and reducing heat loss.

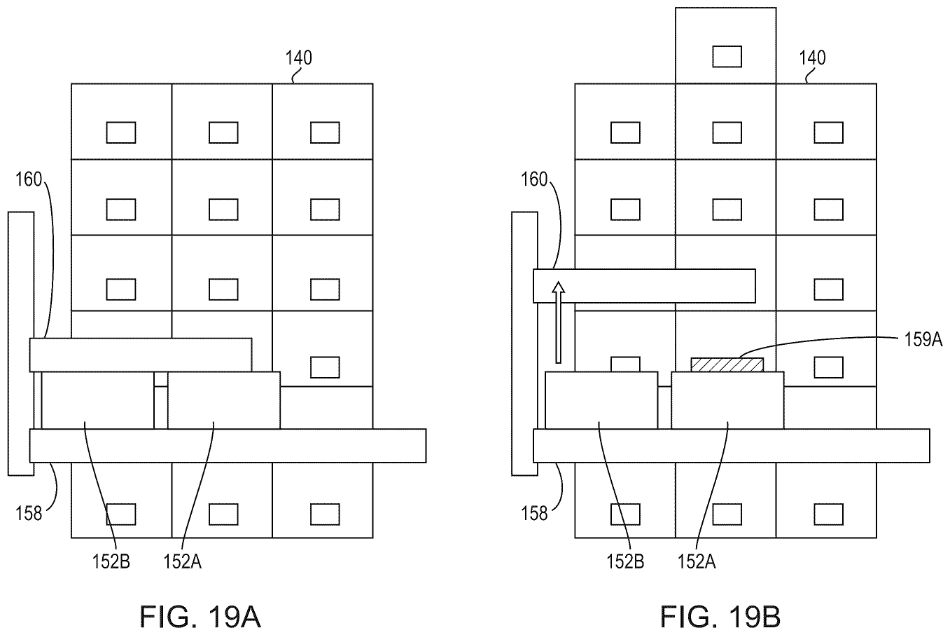

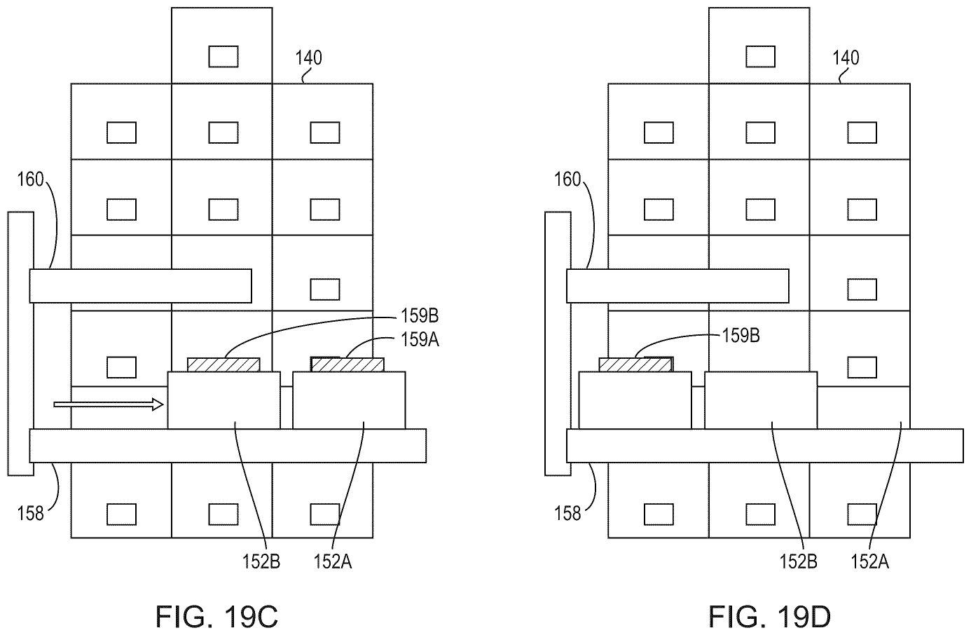

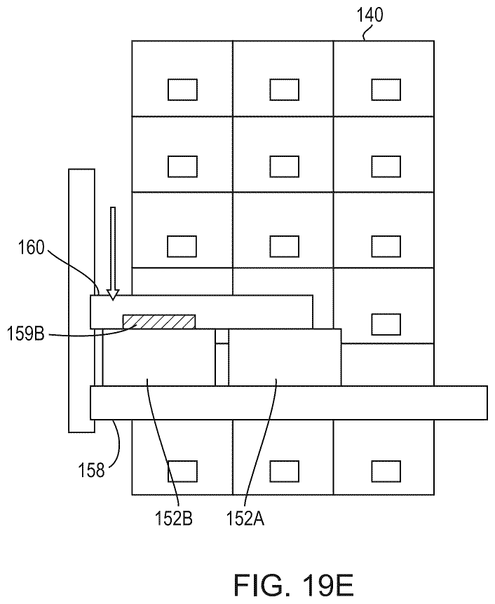

FIGS. 19A-E illustrate an example operation to remove a rear tray from a storage volume:
a) FIG. 19A: The shuttle assembly 130 has aligned a first tray conveyor 152A with a target tile.
b) FIG. 19A: The tile lifter assembly 160 may carry out a tile lifting operation such as the operation described above with reference to FIGS. 16A-E, thereby creating an opening in the tile wall 140 as shown. The first tray conveyor 152A may then extract the front tray 159A through the opening such as described above with reference to FIGS. 17A-D. In doing so, the movement of the front tray 159A may pull the rear tray (which may be latched to the front tray 159A) to a front position within the storage volume 102.
c) FIG. 19A: The lateral axis conveyor 158 may move both of the tray conveyors 152A-B laterally to move the first tray conveyor 152A away from the opening and align the second tray conveyor 152B with the opening, where the rear tray 159B now resides in the front position. The second tray conveyor 152B may then extract the rear tray 159B through the opening such as described above with reference to FIGS. 17A-D.
d) FIG. 19A: If the front tray 159A is to be returned to the storage volume 102, the lateral axis conveyor 158 may again move both of the tray conveyors 152A-B laterally to move the first tray conveyor 152A back to alignment with the opening. The first tray conveyor 152A may then move the front tray 159A through the opening and into the storage volume 102. Alternatively, if both trays 159A-B are targeted for retrieval, then this operation may be omitted.
e) FIG. 19A: The tile lifter assembly 160 may close the opening such as described above with reference to FIGS. 18A-D. The shuttle assembly 130 may then move through the access volume 103 to transport the rear tray 159B to a target transfer module 108 (see FIG. 1A), where the tray 159B or selected samples from the tray 159B may be retrieved by an operator. Alternatively or in addition, the operator may add external samples to the tray 159B when residing in an transfer module 108, where it may be retrieved by the shuttle assembly 130 and returned to the storage volume 102 for cold storage.

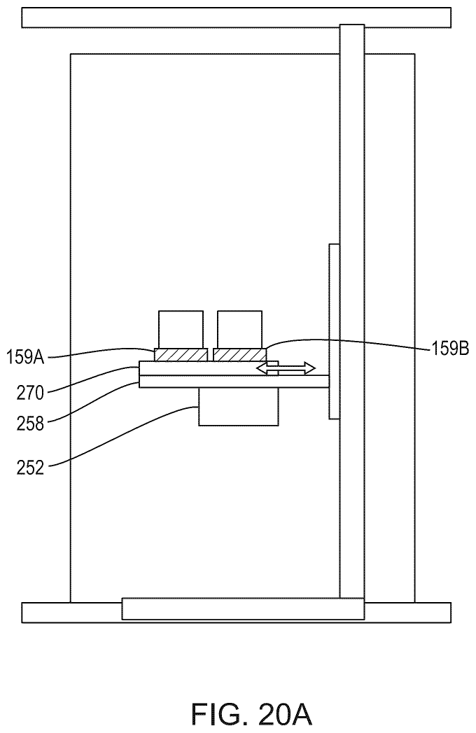

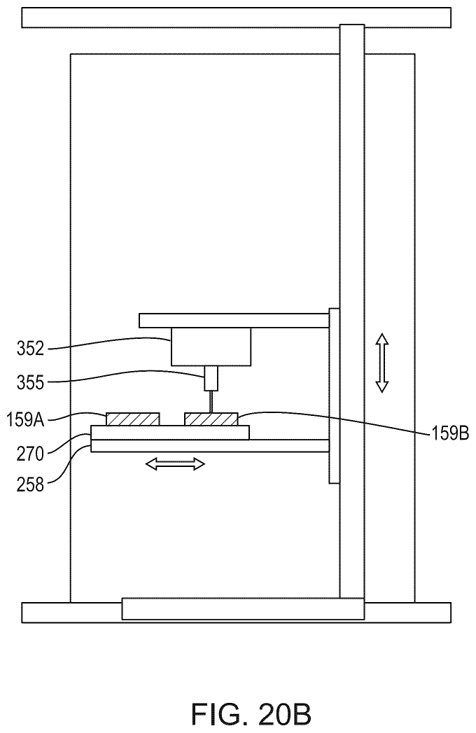

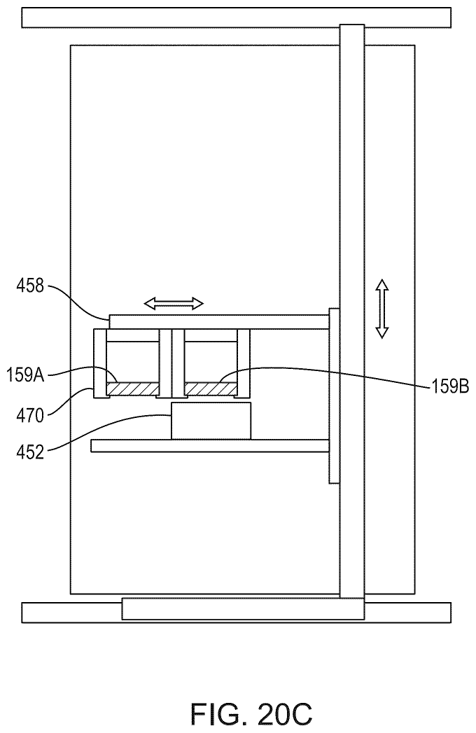

FIGS. 20A-C illustrate example alternative embodiments implementing a single tray conveyor rather than two tray conveyors. In FIG. 20A, a modified tray conveyor 252 may be mounted below a modified lateral axis conveyor 258, and may be configured to extract a trays 159A-B from the storage volume 102 and place it in or on a tray receptacle 270. The receptacle 270 may include guide rails similar to the guide rails 153 described above, and may accommodate multiple trays. During an operation to extract multiple trays from the storage volume 102, the tray conveyor 252 may remain stationary, and may extract each of the trays 159A-B in succession and place them in the tray receptacle 270. For example, the tray conveyor 252 may extract a first tray 159A a place it in the tray receptacle 270. The lateral axis conveyor 258 may then move the tray receptacle 270 laterally, thereby moving the front tray 159A away from the opening and enabling the tray conveyor 252 to extract the rear tray 159B from the storage volume 102. The process may be repeated in reverse to return the trays 159A-B to the storage volume 102. As a result, multiple trays 159A-B may be transported using a single tray conveyor 252.

FIG. 20B illustrates an alternative comparable to that of FIG. 20A, except that a modified tray conveyor 352 is mounted above the lateral axis conveyor 258 rather than below it. To manipulate the trays 159A-B in this configuration, the tray conveyor 352 may include a robotic arm 355 that can extend through the opening in the tile wall 140, engage with the trays 159A-B, and move them into the tray receptacle 270. Thus, the tray conveyor 352 may remain in place while the robotic arm 355 manipulates multiple trays 159A-B and the lateral axis conveyor 258 moves the tray receptacle 270 to reposition the trays 159A-B as described above.

FIG. 20C illustrates a further alternative comparable to those of FIGS. 20A-B. Here, a single tray conveyor 452 may remain stationary at an opening to access trays in the storage volume 103. A modified lateral axis conveyor 458 may suspend a hanging tray receptacle 470 above the tray conveyor 452. The hanging tray receptacle 470 may include guide rails similar to the guide rails 153 described above, and may accommodate multiple trays, such as the trays 159A-B as shown. During an access operation, the tray conveyor 452 may remove the front tray 159A and place it in the hanging tray receptacle 470, which the lateral axis conveyor 458 then moves to reposition the front tray 159A away from the opening. The tray conveyor 452 may then access and extract the rear tray 159B from the storage volume 102 and add it to the hanging tray receptacle 458.

### Sample Trays

Sample trays may shrink as its temperature decreases, and the degree of shrinkage depends on its initial dimensions and material composition. For example, when a sample tray is transferred from a room at ambient temperature (e.g. 20° C.) to a storage volume at −80° C., its length may reduce by 3-4 mm. This reduction can make it difficult to predict where the end of the tray will be once it is placed into storage, as a portion of the tray could eventually be 4 mm away from where it was left. As a result, it may be difficult for retrieval mechanisms, such as the tray latch assembly 155 described above, to engage with the latch of the tray, and could result in a failed access operation.

Example embodiments may overcome the challenges of tray shrinkage via a particular latch configuration and latching process. For example, a latching feature of an approaching robot or a tray may first make contact with a target tray, then push the target tray back (e.g., by 4 mm). The approaching latching feature may then be lifted or dropped to fully engage with the tray. The target tray can then be pulled from the store or pushed back to the far storage location. Depending on whether the target tray is being connected with a tray in the front enclosure or the rear enclosure, the engagement movement may be upwards or downwards.

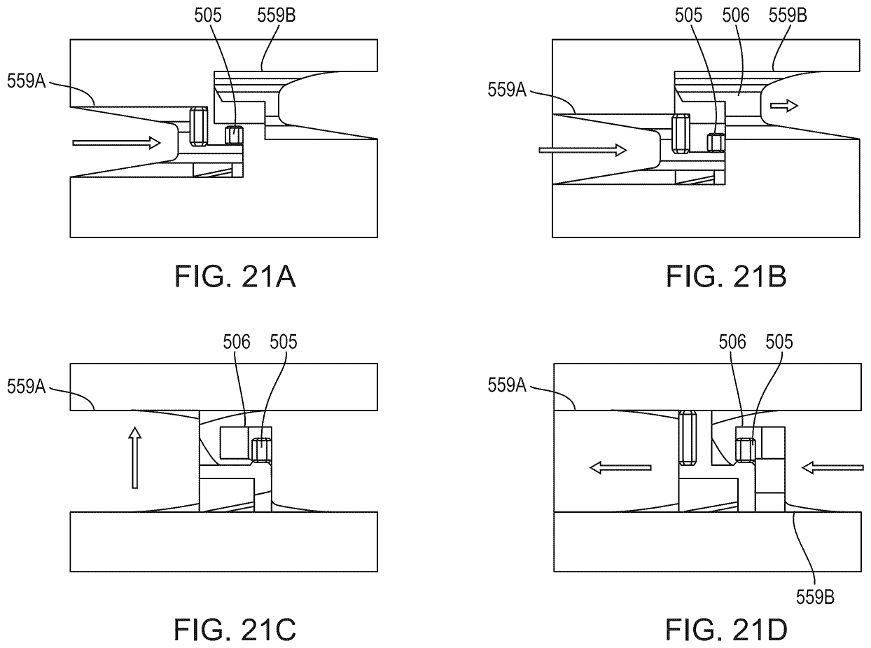

FIGS. 21A-D illustrate an example tray latching operation. Although a pair of trays 559A-B is shown, the operation may be adapted to join a tray and a latch of a tray conveyor 152, such as the tray latch 185 described above, or other robotics.
a) FIG. 21A: A first tray 559A may be positioned such that a bottom surface of the first tray is lower than a bottom surface of a second tray 559B. The first tray 559A may be moved towards the second tray 559B, or the second tray 559B may be moved towards the first tray 559A, or both.
b) FIG. 21B: The trays 559A-B may make contact, such as between a bolt of the first tray 559A and a surface of the second tray 559B below a slot 506 of the second tray 559B. As shown in the cross-section view of FIGS. 21C-D, the slot 506 may be longer than a width of the bolt 505.
c) FIG. 21C: The first tray 559A may then be elevated relative to the second tray 559B until the bolt 505 enters the slot 506 of the second tray 559B.
d) FIG. 21D: The first tray 559A may be moved away from the second tray 559B, or the second tray 559B may be moved away from the first tray 559A, or both. As a result, the trays 559A-B are latched in a manner that may succeed regardless of any relocation of the latching mechanisms due to shrinkage.

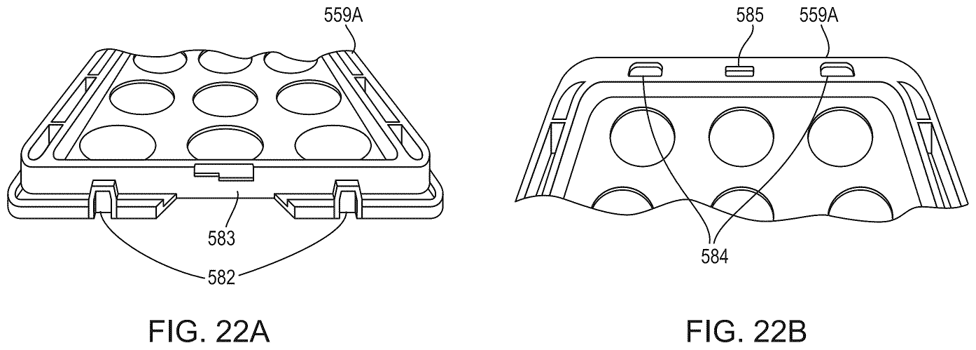

FIGS. 22A-B are diagrams illustrating connection features of a tray in one embodiment. FIG. 22A shows “male” connectors at one end of the tray 559A, while FIG. 22B shows “female” connectors at an opposite end of the tray 559A. In FIG. 22A, a pair of tray connection features 582 may be protrusions comparable to the bolt 505 described above, and a latch connection feature 583 may be a similar protrusion for connecting with a latch such as the latch 185 described above. Similarly, in FIG. 22B, a pair of tray connection features 584 may be apertures or slots comparable to the slot 505 described above, and a latch connection feature 585 may be a similar aperture or slot for connecting with a latch such as the latch 185 described above.

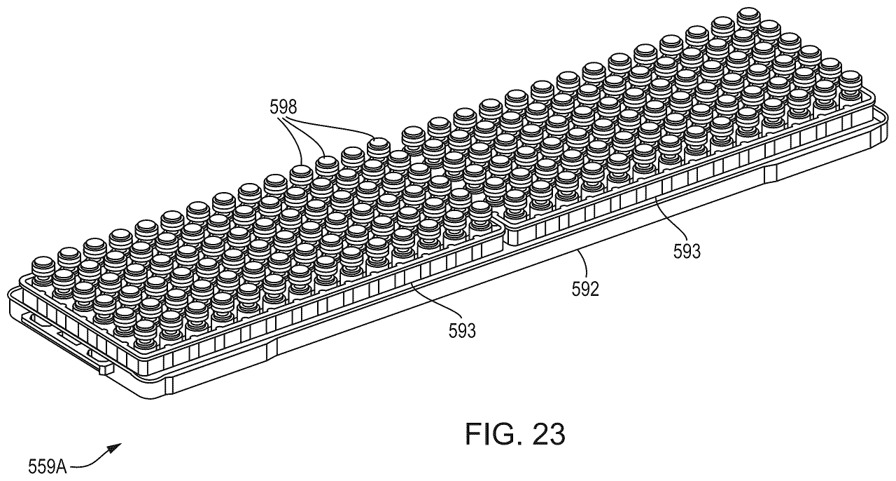

FIG. 23 illustrates the storage tray 559A loaded with sample tubes 598. The storage tray 559A may include a tray base 592, which may be formed of a rigid material and may define the tray connection features 582-585 described above. The tray base 592 may also form one or more cavities in which tray inserts 593 may be held. The tray inserts 593 may be formed of a rigid or flexible material, and may form several openings for accommodating and holding in place each of the sample tubes 598.

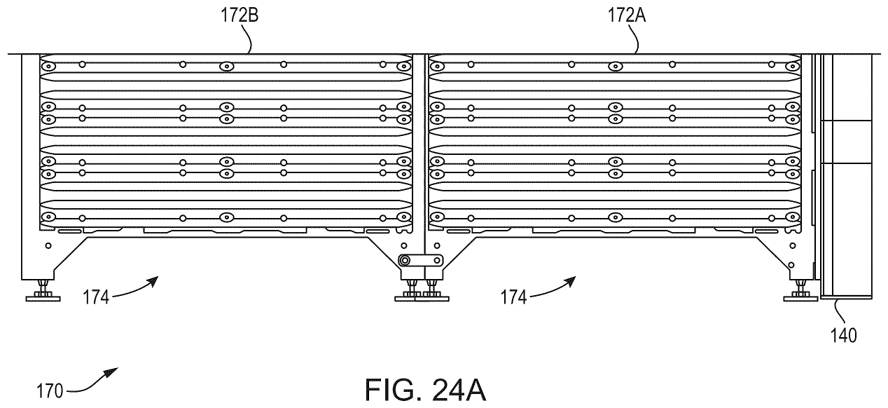

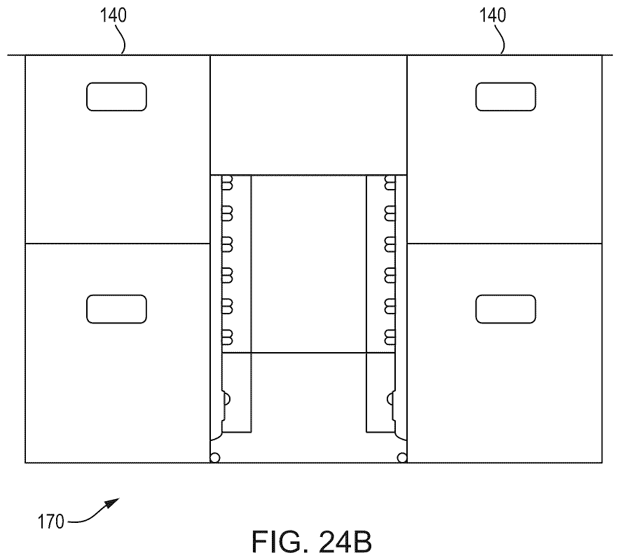

FIGS. 24A-B illustrates a storage partition assembly 170 in one embodiment. FIG. 24A shows a side view of the assembly 170 as installed within a storage volume 102 behind a tile wall 140. The assembly 170 includes two columns 172A-B of storage shelves 174, wherein the front column 172A and rear column support storage trays 559A-B that are stored at the front and rear of the storage volume, respectively.

FIG. 24B shows a front view of the storage partition assembly 170 as visible through an opening in the tile wall 140. Here, it can be seen that each of the storage shelves 174 may extend a given distance from a support structure, thereby providing support to storage trays while enabling air flow through the storage volume 102.

While example embodiments have been particularly shown and described, it will be understood by those skilled in the art that various changes in form and details may be made therein without departing from the scope of the embodiments encompassed by the appended claims.

What is claimed is:

1. An automated storage system, comprising:
a cold storage compartment having a plurality of tray guide rails and tray support racks, the cold storage compartment having an access side comprising columns of insulated tiles;
a tray shuttle compartment adjacent to the storage compartment access side;
a tray shuttle disposed within the tray shuttle compartment, the tray shuttle including:
a first robotic arm configured with a projection to engage a first tile and a second robotic arm configured with a projection to engage a second tile at the top of one of the columns of tiles, whereby the first arm operates in the first direction to create an aperture through which trays can be retrieved from the storage compartment and the second arm operates in the direction opposite to the first arm to close the tiles after retrieval or storage of the tray; and
a tray shuttle conveyor comprising a transport configured for translating horizontally or vertically within the tray shuttle compartment and aligning with a tray accessible by an aperture created by the first robotic arm, wherein the tray shuttle compartment is adapted such that each tray support rack of the cold storage compartment is independently accessible by the tray shuttle in the tray shuttle compartment;
an air conduit having one end connected to a refrigeration unit and one or more remaining sides connected to the storage compartment, the air conduit including openings to the storage compartment with projections extending from the openings into the air conduit to direct the flow of cold air from the refrigeration unit to the storage compartment;
an input-output module for transferring a tray for storage to or from the cold storage compartment; and
a controller directing operation of the cold storage compartment, the tray shuttle and the input-output module.

2. A system for controlling temperature of an environment, comprising:
a heat exchanger;
an input duct adapted to direct air from a first environment to a gas input of the heat exchanger;
an output duct adapted to direct a gas output from the heat exchanger into the first environment;
a refrigerator configured to cool a second environment to a temperature lower than that of the first environment, the refrigerator including a liquid reservoir to cool the refrigerator; and
a conduit loop adapted to cycle liquid from the liquid reservoir through the heat exchanger, the heat exchanger being configured to transfer thermal energy from the liquid to the air from the first environment.

3. The system of claim 2, wherein the first and second environments are adjacent to one another.

4. The system of claim 2, wherein the first and second environments are separated by a wall including at least one moveable panel enabling passage through the wall.

5. The system of claim 4, wherein the first environment is cooled by convection via the passage.

6. The system of claim 2, wherein the refrigerator is configured to cool the second environment to a temperature of −80° C. or less.

7. The system of claim 2, wherein the heat exchanger is configured to heat the first environment to a temperature of at least −25° C.

8. The system of claim 2, further comprising a chiller unit connected in series with the conduit loop and configured to cool the liquid.

9. The system of claim 2, wherein the heat exchanger is further configured to selectively enable operation based on a detected temperature of the air from the first environment.

10. The system of claim 2, wherein the second environment is a cold storage environment including a plurality of samples, and wherein the first environment includes at least one mechanism for accessing the plurality of samples.

11. A system for directing air, comprising:
an air duct adapted to carry a flow of cooled air; and
a chamber adjacent to the air duct;
a wall of the air duct defining a plurality of deflectors extending from a surface of the wall into the air duct, the plurality of deflectors 1) being located at distinct distances from an inlet of the air duct and 2) being adapted to direct respective portions of the flow of cooled air through respective apertures in the wall and into the chamber.

12. The system of claim 11, wherein each of the plurality of air deflectors further include a portion extending from a surface of the wall into the chamber.

13. The system of claim 11, wherein the plurality of deflectors extending from a surface of the wall in a direction toward a source of the flow of cooled air.

14. The system of claim 11, wherein the chamber encompasses a plurality of partition walls dividing a volume of the chamber into a plurality of zones adjacent to the wall of the air duct.

15. The system of claim 14, wherein each of the plurality of deflectors is adapted to direct the respective portion of the flow of cooled air into a respective one of the plurality of zones.

16. The system of claim 11, wherein the chamber encompasses a plurality of columns of trays.

17. The system of claim 16, wherein each of the plurality of deflectors is adapted to direct the respective portion of the flow of cooled air through a respective one of the plurality of columns of trays.

18. The system of claim 16, wherein each of the plurality of deflectors is adapted to direct the respective portion of the flow of cooled air through a respective volume between two of the plurality of columns of trays.

19. The system of claim 16, wherein each of the plurality of columns of trays includes trays having perforations that enable the flow of cooled air to pass through the column of trays.

20. The system of claim 16, wherein each of the plurality of columns of trays includes trays storing a plurality of biological samples.

21. The system of claim 11, wherein the flow of cooled air is at a cold temperature.

22. A storage system comprising:
a storage chamber;
a column of tiles integral to a wall of the storage chamber;
a vertical track adapted to enable the column of tiles to slide vertically along the wall of the storage chamber;
a first robotic arm, wherein, during an opening operation, the first robotic arm is configured to lift a subset of the column of tiles upwards along the vertical track to create an aperture in the wall in place of a selected tile, the subset including the selected tile and tiles located above the selected tile.

23. The system of claim 22 further comprising:
a second robotic arm positioned above the first robotic arm, wherein, during a closing operation, the first and second robotic arms are configured to engage with distinct tiles of the subset and lower the subset downward to seal the aperture.

24. The system of claim 23, wherein, during the closing operation, the first and second robotic arms maintain a seal between each of the subset of tiles.

25. The system of claim 23, wherein, during the closing operation, the first robotic arm engages with the selected tile.

26. The system of claim 23, wherein, during the closing operation, the second robotic arm engages with a topmost tile of the subset of tiles.

27. The system of claim 23, further comprising a plurality of columns of tiles integral to the wall of the storage chamber, the plurality of columns of tiles including the column of tiles.

28. The system of claim 27, wherein the first and second robotic arms are configured to move horizontally to a selected one of the plurality of columns of tiles prior to an opening operation.

29. The system of claim 22, further comprising a conveyor robot, wherein, following the opening operation, the conveyor robot is configured to remove an item from the storage chamber via the aperture.

30. The system of claim 28, wherein the item is a tray supporting a plurality of biological samples.

31. A method of accessing a storage unit, comprising:
moving a track such that first and second conveyor robots are vertically aligned with a selected port of a storage unit, the track supporting the first and second conveyor robots;
moving the first conveyor robot such that it is horizontally aligned with the selected port;
via the first conveyor robot, extracting a first tray through the selected port and moving the first tray horizontally along the track;
positioning the second conveyor robot such that it is horizontally aligned with the selected port;
via the second conveyor robot, extracting a second tray through the selected port and moving the first tray horizontally along the track;
via the first conveyor robot, returning the first tray to the storage unit through the selected port.

32. The method of claim 30, further comprising opening a panel covering the selected port prior to extracting the first tray.

33. The method of claim 30, further comprising closing a panel covering the selected port after returning the first tray to the storage unit.

34. The method of claim 30, further comprising, via the second conveyor robot, moving the second tray to an external access port.

35. The method of claim 30, wherein the selected port is a first port of a plurality of ports at the storage unit, and further comprising:
moving the track vertically such that first and second conveyor robots are vertically aligned with a second port of the storage unit;
moving the first conveyor robot such that it is horizontally aligned with the second port; and
via the first conveyor robot, extracting a third tray through the second port and moving the second tray horizontally along the track.

36. The method of claim 34, further comprising:
positioning the second conveyor robot such that it is horizontally aligned with the second port;
via the second conveyor robot, extracting a fourth tray through the second port and moving the third tray horizontally along the track;
via the first conveyor robot, returning the third tray to the storage unit through the second port.

37. A method of connecting trays, comprising:
positioning a first tray such that a bottom surface of the first tray is lower than a bottom surface of a second tray;
moving at least one of the first and second trays toward one another until a connector of the first tray contacts a surface of the second tray below a slot of the second tray, the slot being longer than a width of the connector;
elevating the first tray relative to the second tray until the connector enters the slot of the second tray; and
moving at least one of the first and second trays away from one another such that the connector moves within the slot until the connector contacts an end of the slot.

38. The method of claim 36, further comprising, prior to elevating the first tray relative to the second tray, pushing one of the first and second trays via the other of the first and second trays.
